(19) United States
(12) Patent Application Publication
(10) Pub. No.: US 2026/0206771 A1
(43) Pub. Date: Jul. 23, 2026

(54) Improved Almond-based Pasta Flour, Almond-Based Pasta Products, Methods of Manufacturing Almond-Based and Other Nut-Based Pasta, Psyllium Serum Binder Systems, and Specialized Extrusion Dies for High-Oil Gluten-Free Dough Processing

(71) Applicant: Nuda Foods LLC, North Andover, MA (US)

(72) Inventors: James Vitas II, New York, NY (US); Jesse Dixon, Bedford, NH (US); Dave Everett, Boston, MA (US); Mark Dimond, Grafton, MA (US); Allen Campbell, Boston, MA (US); Kyle Townson, Santa Monica, CA (US); Jason Lin, Cupertino, CA (US)

(21) Appl. No.: 19/453,459

(22) Filed: Jan. 20, 2026

Related U.S. Application Data
(60) Provisional application No. 63/746,351, filed on Jan. 17, 2025.

(51) Int. Cl. A21D 2/36; A21C 11/16; A21D 2/18; A21D 2/26; A23L 25/00

(52) U.S. Cl. CPC A21D 2/364; A21C 11/16; A21D 2/186; A21D 2/264; A23L 25/30

(57) ABSTRACT

A gluten-free pasta system is disclosed comprising nano-refined almond-based flour, a psyllium husk serum binder, improved dough preparation methods, and a specialized extrusion die for high-oil doughs. Almond flour, almond protein powder, and tapioca starch are mechanically refined to micron- or sub-micron-scale particle sizes to improve hydration, cohesion, and dough elasticity. A psyllium husk serum is prepared by hydrating and mechanically processing psyllium to form a smooth, uniform gel that enhances binding and structural integrity. The refined flour and serum are combined with water to form a cohesive dough exhibiting reduced oil separation and improved extrusion stability. An improved extrusion die having tapered flow channels, polished or non-stick surfaces, and pressure-modulating features enables stable formation of pasta shapes from high-oil doughs. Methods of manufacturing pasta and related extruded food products using the disclosed compositions and systems are also provided.

### REFERENCE TO RELATED APPLICATION

This application claims the benefit of priority under 35 U.S.C. § 119(e) to U.S. Provisional Patent Application No. 63/746,351, filed Jan. 17, 2025, titled “Improved Almond-based Pasta Flour, Almond-Based Pasta, Methods of Manufacturing Thereof, Improved Binder for Almond-Based Pasta, and Improved Extrusion Dies for Almond-Based Pasta Manufacturing,” the entire contents of which are incorporated herein by reference.

### FIELD OF THE INVENTION

The present invention relates generally to food science, food processing, and gluten-free food product manufacturing. More specifically, the invention pertains to almond-based and other nut-based pasta flour compositions, almond-based and nut-based pasta products, and methods of manufacturing such products, including processes involving mechanical particle-size refinement to micron and sub-micron scales. The invention further relates to psyllium-based binder systems, including psyllium husk serum formulated to enhance binding, hydration, and texture in gluten-free dough systems. Additionally, the invention concerns specialized extrusion dies designed for processing high-oil-content doughs such as almond-based dough, and methods for extruding, shaping, and drying gluten-free pasta and related food products.

### BACKGROUND OF THE INVENTION

Gluten-Free and Nut-Based Flours: Gluten-free demand has grown due to health, allergy, and dietary preferences. Wheat flour contains gluten, which provides elasticity and cohesive structure in dough. Nut-based flours such as almond flour offer favorable nutrition (protein, healthy fats, fiber) but differ fundamentally from wheat flour: they lack gluten or similar network-forming proteins; they contain high lipid levels that disrupt structure; and commercial products have heterogeneous particle size. As a result, nut-based flours perform poorly in pasta and structured extruded foods without extensive formulation work.

Conventional almond-based doughs have multiple limitations. Standard almond-based doughs have poor cohesion and elasticity due to the absence of gluten. Their high oil content acts as an internal lubricant, weakening the dough and causing cracking, shape loss, and “oiling out” during processing. Further, these doughs have broad particle-size distribution that leads to uneven hydration and weak spots. Existing gluten-free formulations often rely on gums, starches, or egg, which create sticky, rubbery, brittle, or otherwise undesirable textures, and do not deliver the mechanical strength, extrusion stability, and cooking quality expected of wheat pasta.

Moreover, gluten-free pasta manufacturing is extremely challenging. For instance, gluten-free pasta dough must withstand hydration, mixing, extrusion, cutting, and drying without gluten's viscoelastic network. During manufacturing, commonly encountered problems include: (a) fragmentation and crumbling during mixing and extrusion; (b) difficulty forming continuous strands and conventional pasta shapes; (c) over-reliance on multi-component binder systems that still underperform; (d) inconsistent hydration leading to poor and variable cooking performance; (e) sensitivity to heat and shear, causing deformation and breakage; and (f) brittleness and cracking after drying. These problems thus limit yield, shape options, and consumer acceptance.

Gluten-free products often employ psyllium husk powder for water absorption and gel formation. However, in nut-based pasta doughs, use of psyllium husk powder causes additional problems and shortcomings. It hydrates unevenly, forming clumps and non-uniform gel zones. It interacts poorly with high-oil systems because lipids inhibit wetting. It is highly sensitive to mixing order and shear, making industrial reproducibility difficult. It offers limited control over viscosity and distribution, leading to localized stiffness and weak zones. And it often leaves partially hydrated particles that weaken the dough and contribute to brittleness. Accordingly, conventional psyllium powder is suboptimal for high-performance nut-based pasta.

Commercial almond flour, almond protein powder, and tapioca starch themselves have their own shortcomings, including non-uniform hydration and incomplete binding, weak mechanical strength and crumbly dough, grainy texture and uneven surface in finished pasta, reduced binder efficiency and poor gel network formation, and increased risk of oil pockets and oiling out in high-oil doughs.

Almond and other nut-based doughs are high in natural oils and lack gluten and, thus, conventional and currently available extrusion technologies and processes further result in yet additional shortcomings for these types of products, including generation of excessive shear and heat during manufacture, which promotes oil separation, production of unstable flow, pressure spikes, and clogging; and allowance of oiling out at the die face thereby degrading product structure and appearance. They also suffer from significant dough adhesion and fouling, and deliver poor shape definition and dimensional instability, especially for hollow or complex shapes.

### OBJECTS AND SUMMARY OF THE INVENTION

In view of the foregoing, there is a need for an integrated nut-based pasta system that includes, in part or in whole, a nut-based flour composition engineered for pasta, a binder specially designed to hydrate and to provide uniform distribution, refinement of the manufacturing processes tailored to address some, most or all of the above-mentioned shortcomings of conventional nut-based pasta, extrusion technology tailored for high-oil gluten-free doughs, and integrated methodologies for dough preparation, extrusion, and drying that yield nut-based pasta that matches or exceeds wheat-based pasta in structure, texture, and cooking performance.

Accordingly, the present invention provides, in certain embodiments, improved almond-based flour. In particular, the present invention provides an improved almond-based flour specifically engineered for use in pasta and other structured food products. Unlike conventional almond flours, which exhibit coarse and heterogeneous particle sizes and lack the cohesive properties required for dough formation, the inventive flour described herein is produced using controlled particle-size refinement techniques that reduce the almond flour, almond protein powder, tapioca starch, and optional psyllium components to micron- or sub-micron-scale dimensions.

In certain embodiments, the improved almond-based flour comprises almond flour, almond protein powder, tapioca starch, and optionally psyllium husk or other binders, each processed to achieve a substantially uniform particle-size distribution. The refined ingredients exhibit enhanced surface area, improved hydration dynamics, and superior integration with binder systems, including the psyllium serum described in this invention.

In such embodiments, the resulting flour provides multiple functional advantages over conventional almond flour, including (1) enhanced dough cohesion due to improved particle packing and increased interaction between components; (2) improved hydration uniformity arising from narrower particle-size distribution and refined surface properties; (3) increased elasticity and structural integrity enabling the flour to form stable dough suitable for extrusion into pasta shapes; (4) reduced brittleness in both raw and dried dough, resulting in better processing performance and higher production yield; and (5) superior texture and mouthfeel in the finished pasta product, including smoother surfaces, more uniform density, and improved bite.

In further embodiments, the improved almond-based flour incorporates alternative nut-based ingredients, such as hazelnut, cashew, pistachio, or macadamia flours. Preferably, these ingredients undergo similar particle-size refinement processes. Accordingly, the present invention supports a wide range of gluten-free, grain-free pasta and extruded food applications.

As discussed, the improved flour in the various embodiments serves as the foundational component for the doughs, binder systems, extrusion methods, and final pasta products disclosed herein.

In further embodiments, the present invention provides a particle-size refinement process that transforms almond flour, almond protein powder, tapioca starch, and optional binder materials into micron-scale or sub-micron-scale particles through controlled mechanical processing. This refinement process—referred to herein as nano-technology processing or the nano-refinement process—significantly improves the performance of nut-based doughs by increasing ingredient uniformity, enhancing hydration behavior, and enabling the formation of cohesive, structurally stable matrices suitable for pasta and other extruded food products.

In certain embodiments, the refinement process employs one or more advanced milling techniques, including cryogenic grinding, jet milling, ball milling, ultrasonic milling, or other high-precision particle-size reduction methods. These processes are capable of producing particles with narrow size distributions and substantially reduced average diameters relative to conventional flours.

As a result of the refinement process in accordance with the present invention, the ingredients exhibit the following desired attributes: increased surface area, allowing for more efficient interaction with water and binder systems; uniform hydration kinetics, resulting in consistent dough development and reduced variability; improved cohesiveness and structural reinforcement, compensating for the absence of gluten in nut-based formulations; enhanced mechanical resilience, enabling doughs to withstand the pressures and shear forces associated with extrusion and cutting; and superior cooking performance and texture, including smoother surfaces, more uniform density, and improved bite in the finished pasta.

The nano-refinement process also, in accordance with the present invention, mitigates the challenges caused by the natural lipid content of almond and other nut flours. In certain embodiments, reducing particle size and improving distribution reduces oil separation during extrusion and promotes stable dough flow through both conventional and specialized dies.

The nano-refined ingredients created through this process form the functional basis of the improved dough systems and pasta products disclosed herein and may be used alone or in combination with the psyllium serum binder and extrusion die technologies described in subsequent sections.

The present invention additionally introduces a novel psyllium husk serum, which functions as an improved binding and hydration system for almond-based and other nut-based dough formulations. Unlike conventional psyllium husk powder, which hydrates inconsistently and forms localized gel clumps, the psyllium husk serum of the present invention is produced through a controlled hydration and mechanical processing method that transforms psyllium into a smooth, uniform, serum-like material with superior functional properties.

In certain embodiments, the psyllium husk serum is prepared by hydrating psyllium husk powder in a controlled water-to-solid ratio, followed by high-shear mixing, homogenization, ultrasonic treatment, or other mechanical refinement techniques. These processes break down the fibrous structure of the psyllium husk, yielding a continuous gel-like matrix with improved viscosity control, enhanced water retention, and improved dispersion characteristics.

In accordance with the present invention, the psyllium husk serum provides multiple advantages when incorporated into nut-based dough systems, including: (1) uniform distribution within the dough, reducing the formation of localized clumps or under-hydrated particles and promoting consistent matrix formation; (2) enhanced binding efficiency, enabling the serum to act as a cohesive agent that compensates for the absence of gluten in almond and other nut flours; (3) improved dough elasticity and extensibility, facilitating extrusion and enabling the formation of stable pasta shapes; (4) superior integration with nano-refined ingredients, as the serum's smooth structure interacts more effectively with micron- and sub-micron-scale particles; and (5) reduced brittleness and cracking during extrusion, drying, and cooking, resulting in improved product quality and yield.

In certain embodiments, the psyllium husk serum completely replaces psyllium husk powder in the formulation. In other embodiments, the serum may be used in combination with powdered psyllium or other binders to further enhance the dough's mechanical properties.

This novel psyllium husk serum represents a critical advancement in binder technology for gluten-free and grain-free pasta, enabling the production of dough systems that more closely replicate the rheological and structural characteristics of traditional wheat-based doughs.

The present invention further provides an improved extrusion die specifically engineered for the processing of high-oil, gluten-free doughs such as almond-based doughs. Traditional pasta extrusion dies are designed for wheat-based doughs with viscoelastic gluten networks and relatively low lipid content. As a result, conventional dies generate excessive heat and shear, promote oil separation (“oiling out”), and fail to deliver uniform shaping when applied to nut-based formulations.

The extrusion die of the present invention incorporates specialized geometric, surface, and flow-channel features that collectively stabilize dough behavior during extrusion and enable the production of structurally consistent pasta shapes from almond-based or other nut-based doughs.

In certain embodiments, the improved extrusion die includes one or more of the following features: (1) optimized flow channel geometry, such as tapered channels, gradual transitions, and pressure equalization structures that reduce shear-induced heating and minimize oil separation within the dough; (2) surface treatments, including polished, electropolished, or non-stick coatings that reduce dough adhesion, promote smooth flow through the die, and mitigate fouling associated with high-lipid mixtures; (3) pressure-relief grooves or flow balancing structures that help maintain uniform pressure distribution across the dough mass, thereby reducing deformation or breakage at the die exit; and (4) thermal management features, such as integrated cooling channels or thermally insulating materials, that limit heat accumulation caused by mechanical friction and ensure stable extrusion temperatures.

Through these integrated design features, the improved extrusion die provides multiple functional benefits, including: (1) reduced oiling out, enabling more stable dough matrices and higher-quality extrudates; (2) improved dimensional stability, allowing almond-based doughs to form and retain traditional pasta shapes without collapse or fracture; (3) enhanced extrusion consistency, promoting continuous flow, minimized clogging, and reduced downtime during production; and (4) superior surface and structural characteristics in the finished pasta, achieved through smoother die-wall interactions and optimized flow dynamics

In certain embodiments, the improved die is retrofitted to existing extrusion systems, enabling manufacturers to process high-oil gluten-free doughs without requiring extensive modifications to existing equipment.

The inventive extrusion die, in combination with the nano-refined flour systems and psyllium husk serum binder described herein, further enables the production of high-performance almond-based and nut-based pasta products with structural integrity and sensory qualities comparable to wheat-based pasta.

The present invention further provides improved almond-based and other nut-based pasta products, as well as methods of manufacturing such products, utilizing the nano-refined flour compositions, psyllium husk serum binder systems, and specialized extrusion dies described herein. The combined use of these components enables the formation of doughs with significantly enhanced cohesiveness, elasticity, and mechanical stability relative to conventional gluten-free formulations.

In certain embodiments, the manufacturing methods comprise combining nano-refined ingredients, including almond flour, almond protein powder, tapioca starch, and optionally binders, into a uniform dry mixture; pre-sifting one or more dry ingredients prior to mixing to improve uniformity and reduce agglomeration; hydrating and mixing the ingredients using controlled water addition and mechanical mixing to produce a cohesive dough with improved structural integrity; incorporating the psyllium husk serum, either as a complete replacement for powdered psyllium or in combination with it, to enhance the dough's elasticity, hydration uniformity, and extrusion stability; extruding the dough through the improved extrusion die, which stabilizes flow, reduces oil separation, and enables the formation of well-defined pasta shapes; and drying the extruded pasta under controlled temperature and humidity conditions to yield shelf-stable pasta products with desirable texture, reduced brittleness, and enhanced cooking performance.

In accordance with the present invention, the resulting pasta products exhibit several advantages including: improved structural integrity, including reduced breakage during extrusion, drying, packaging, and cooking; smooth and uniform texture, enabled by the combination of micronized particles and serum-based binding; enhanced cooking performance, with pasta maintaining shape, firmness, and desirable mouthfeel during and after cooking; consistent dimensional accuracy, even in complex shapes or hollow pasta forms, due to the optimized extrusion die geometry; and superior consumer acceptability, with textures and sensory attributes more closely resembling those of wheat-based pasta.

In additional embodiments, the above summarized manufacturing method is carried out without all the identified steps, or with alternative steps as herein described due to the extreme variability of the disclosed inventive methods.

In further embodiments, the methods disclosed herein may be applied to a variety of nut-based flour systems, including hazelnut, pistachio, cashew, walnut, macadamia, and others, provided the ingredients undergo similar particle-size refinement and binder integration processes.

In accordance with the present invention, the integrated system of improved flour compositions, serum-based binders, and optimized extrusion techniques provides a novel, comprehensive solution for manufacturing high-quality gluten-free and grain-free pasta products.

The combination of nano-refined flour compositions, psyllium husk serum binder systems, and specialized extrusion dies provides a comprehensive advance in the manufacture of almond-based and other nut-based pasta products. The integrated technologies disclosed herein address longstanding challenges in gluten-free and grain-free pasta production and collectively deliver significant functional, mechanical, and sensory improvements over conventional formulations and manufacturing methods.

The present invention, in certain embodiments, enhances dough cohesion and stability. In particular, the micronized and sub-micronized ingredients produced through the refinement processes described herein exhibit improved particle uniformity and increased surface area, enabling stronger interactions among dough components. This results in doughs that are more cohesive, less prone to tearing or crumbling, and structurally more robust during mixing and extrusion.

The present invention, in certain embodiments, has superior hydration and binder performance. In particular, the psyllium husk serum provides uniform hydration, smoother gel formation, and enhanced binding efficiency compared to traditional psyllium powder. When combined with nano-refined ingredients, the serum supports the development of dough matrices with improved elasticity, extensibility, and texture.

The present invention, in certain embodiments, has improved extrusion performance. In particular, the specialized extrusion dies disclosed herein are designed to accommodate the unique rheology of high-oil, gluten-free doughs. These dies reduce oiling out, minimize thermal and shear stress, stabilize pressure across the dough mass, and enable consistent flow through the die. Manufacturers benefit from fewer extrusion interruptions, reduced waste, and more uniform output.

The present invention results in high-quality pasta products. The resulting pasta products exhibit characteristics that closely resemble or surpass those of traditional wheat-based pasta, including smooth, uniform surface finish; enhanced firmness and bite; reduced brittleness after drying; better shape retention during cooking; and consistent dimensional accuracy across batches. These improvements enhance consumer satisfaction and support broader market adoption of nut-based pasta products.

The present invention is versatile and adaptable to broad application. The disclosed technologies are compatible with a variety of nut-based and gluten-free formulations, including those derived from hazelnuts, cashews, pistachios, walnuts, macadamia nuts, and others. Additionally, the improved flour and binder systems may be applied beyond pasta to bread, snacks, cereals, and other extruded or baked products requiring cohesive, structurally stable dough matrices.

The present invention presents manufacturing efficiency and scalability. The integrated system described herein facilitates reliable, repeatable manufacturing outcomes with fewer processing disruptions. Improved dough behavior, reduced extrusion fouling, and more consistent drying performance support higher throughput and broader scalability in commercial production environments.

In yet further embodiments and aspects, and as also specified in the accompanying claims, the present invention further includes, in summary, the following.

In accordance with one embodiment, a flour composition comprises almond flour refined to an average particle size of between 0.1 microns and 10 microns; almond protein powder refined to an average particle size of between 0.1 microns to 10 microns; and tapioca starch refined to an average particle size of between 0.1 microns and 10 microns; wherein the flour composition exhibits a substantially uniform particle-size distribution and is configured to form a cohesive, gluten-free dough suitable for extrusion into pasta.

As an aspect of this embodiment, the almond flour comprises 30 percent to 80 percent by weight of the flour composition. As another aspect, the almond protein powder comprises 5 percent to 40 percent by weight of the flour composition. As a further aspect, the tapioca starch comprises 5 percent to 25 percent by weight of the flour composition.

As yet another aspect, the flour composition further comprises psyllium husk powder refined to an average particle size of between 0.1 microns and 10 microns.

As yet an additional aspect, at least 80 percent of all particles fall within ±20 percent of the mean particle size. As still yet a further aspect, one or more of the almond flour, the almond protein powder, and the tapioca starch is refined to an average particle size below 1 micron.

In accordance with another embodiment, a dough composition comprises a flour composition comprising almond flour, almond protein powder, and tapioca starch, each refined to an average particle size of between 0.1 microns and 10 microns; a psyllium husk serum including hydrated psyllium husk subjected to mechanical refinement to form a smooth, gel-like medium; and water; wherein the dough composition exhibiting improved elasticity, cohesiveness, and reduced oil separation relative to dough compositions comprising unrefined almond flour.

As an aspect of this embodiment, the psyllium husk serum comprises 1 part psyllium husk to 10 to 25 parts water by weight. As another aspect of this embodiment, the psyllium husk serum has been processed via one or more of high-shear mixing, homogenization, and ultrasonic cavitation.

As a further aspect of this embodiment, the dough composition exhibits reduced brittleness after drying compared with dough comprising unrefined almond flour. As an additional aspect, the almond flour is partially defatted prior to refinement.

As yet another aspect, the dough composition further comprises flour derived from one or more of hazelnut, cashew, pistachio, walnut, macadamia, and pecan.

In accordance with a method embodiment, a method of producing a dough suitable for gluten-free pasta comprises the steps of refining each of almond flour, almond protein powder, and tapioca starch to an average particle size of between 0.1 microns and 10 microns; preparing a psyllium husk serum by hydrating psyllium husk in water and mechanically processing the hydrated psyllium to form a uniform, serum-like material; mixing the refined almond flour, refined almond protein powder, and refined tapioca starch to form a dry mixture; adding the psyllium husk serum to the dry mixture to produce a combined mixture; and hydrating and mixing the combined mixture to form a cohesive dough, the formed cohesive dough having structural integrity if extruded.

As an aspect of this method embodiment, refining the almond flour is carried out by one or more of cryogenic grinding, jet milling, ball milling, and ultrasonic milling. As another aspect, the psyllium husk serum is further processed by ultrasonic cavitation to reduce gel microstructures.

As a further aspect, the method comprises the step of allowing the formed cohesive dough to rest for 5 to 20 minutes; and extruding the rested formed cohesive dough.

In accordance with yet other embodiments, a method of manufacturing gluten-free pasta comprises the steps of producing a dough according to any of the prior summarized embodiments (or other embodiments discussed herein); extruding the dough through an extrusion die configured for high-oil doughs; and drying the extruded dough to form a shelf-stable pasta product; wherein extrusion of the dough results in reduced oil separation relative to extrusion of doughs comprising unrefined almond flour.

As an aspect of these embodiments, drying comprises a surface-setting phase, a primary drying phase, and a final conditioning phase. As a further aspect, extrusion is performed using a cold-extrusion pasta press.

In accordance with a further embodiment, an extrusion die for processing high-oil gluten-free doughs comprises a die body wherein the die body has one or more flow channels, each of the flow channels having a tapered geometry configured to reduce shear stress and minimize oil separation during extrusion. The flow channels have a surface finish comprising an electropolished or non-stick coating configured to reduce dough adhesion, and the die body has one or more shaping orifices configured to form an extruded pasta product, wherein the extrusion die is configured to produce dimensionally stable pasta shapes from almond-based doughs.

As an aspect of this die embodiment, the extrusion die has integrated cooling channels configured to dissipate heat generated during extrusion.

As another aspect, the shaping orifices are configured to form hollow pasta shapes including penne, rigatoni, or bucatini.

As a further aspect, the tapered flow channel has a taper angle of between 3 degrees to 10 degrees.

As an additional aspect, the extrusion die further comprises a modular insert configured to allow rapid modification of pasta shapes.

In accordance with a further system embodiment for producing gluten-free pasta, the system comprises a particle-refinement apparatus configured to refine almond flour, almond protein powder, and tapioca starch to particle sizes of between 0.1 microns and 10 microns; a psyllium serum preparation apparatus configured to hydrate and mechanically refine psyllium husk; a dough mixer configured to combine refined flour particles, psyllium serum, and water; and the extrusion die of any of the embodiments described herein, wherein the system is configured to produce extruded nut-based pasta with reduced oil separation and improved structural integrity.

As an aspect of this system embodiment, the system includes a drying system configured to dry pasta at controlled temperatures and humidity levels. As another aspect, the particle-refinement apparatus comprises a multi-stage refinement sequence including cryogenic grinding and jet milling.

As a further aspect, the psyllium serum preparation apparatus comprises a high-shear mixer and an ultrasonic processor.

As yet another aspect, the system is configured to produce non-pasta extruded food products selected from the group consisting of crackers, snacks, cereals, and dough-based foods.

Along with the above-summarized embodiments, objects, advantages, features and other characteristics of the present invention, yet various other embodiments, objects, advantages and features of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1A is a flow diagram illustrating an exemplary process for producing nano-refined almond-based flour and pasta products in accordance with the present invention;

FIG. 1B is a further flow diagram in accordance with the present invention;

FIG. 2 is a graphical representation of particle-size refinement in accordance with the present invention;

FIG. 3 is a schematic diagram depicting an exemplary method of preparing the psyllium husk serum of the present invention;

FIG. 4 is a cross-sectional illustration of an improved extrusion die in accordance with certain embodiments of the present invention;

FIG. 5 is an isometric view of the extrusion die of certain embodiments of the present invention;

FIG. 6 is a schematic illustration of pasta products produced using the compositions and methods disclosed herein; and

FIG. 7 is a comparative diagram showing differences in extrusion behavior, dough integrity, and pasta shape retention between conventional almond-based dough processed through a traditional die and dough formulated and extruded using the systems disclosed in the present invention.

### DETAILED DESCRIPTION OF INVENTION

For purposes of the present disclosure, the following terms, expressions, and definitions are used with the meanings set forth below. Unless expressly stated otherwise, these definitions apply throughout the specification and claims.

Almond flour refers to ground almonds containing natural lipid content, typically produced by mechanical grinding or milling of whole almonds or blanched almonds. Almond flour may include fine, medium, or coarse particle grades and may optionally be defatted to any degree. As used herein, almond flour may include partially defatted or fully defatted almond meal unless otherwise specified.

Almond protein powder refers to a protein-enriched fraction derived from almonds, commonly produced through defatting and mechanical or solvent-based extraction processes. Almond protein powder typically contains reduced lipid content and enhanced protein concentration relative to almond flour.

Nut flour and nut-based flour refer to any flour derived from nuts including, but not limited to, almonds, cashews, hazelnuts, pistachios, walnuts, pecans, macadamia nuts, pine nuts, chestnuts, and combinations thereof. Unless stated otherwise, the term includes full-fat, partially defatted, and fully defatted variants.

Psyllium husk refers to the fibrous coating of seeds from the Plantago ovata plant, typically provided in powdered, flaked, or granular form. Psyllium husk is known for its water absorption and gel-forming properties.

Psyllium husk serum and psyllium serum refer to the herein-described inventive-processed, hydrated form of psyllium husk created by combining psyllium powder with water and subjecting the mixture to mechanical refinement, such as high-shear mixing, homogenization, or ultrasonic treatment, to produce a smooth, continuous gel-like medium with improved dispersion and binding characteristics relative to unprocessed psyllium husk powder.

Binder and binding agent refer to any ingredient or additive that improves cohesion, elasticity, or structural integrity of the dough. Binders may include psyllium (in powdered or serum form), starches, gums, hydrocolloids, proteins, fibers, or combinations thereof.

Nano-refinement, nano-technology processing, and particle-size refinement refer to any mechanical or physical process capable of reducing the particle size of flour components, proteins, starches, or binders to an average size within the range of approximately 0.1 microns to 10 microns. Such processes may include cryogenic grinding, ball milling, jet milling, ultrasonic milling, or other high-precision particle reduction techniques.

Micron-scale and sub-micron-scale refer to particle sizes with average diameters measured in microns (1-10 microns) or fractions of a micron (<1 micron), respectively, unless otherwise stated. These terms describe the particle sizes achieved via the nano-refinement processes disclosed herein.

High-oil dough refers to any dough containing lipid concentrations greater than those typically present in wheat-based doughs. Almond-based doughs are exemplary high-oil doughs due to their inherent fat content, which affects rheological behavior, extrusion characteristics, and structural stability.

Extrusion refers to the process of forcing dough through a die under pressure to form a continuous or shaped product. Extrusion may be performed using auger-driven extruders, piston extruders, or other mechanical systems.

Extrusion die and pasta die refer to a forming tool having one or more flow channels and outlet orifices configured to shape dough into pasta or other extruded food products. As used herein, the term includes dies incorporating specialized geometries, pressure modulation features, or surface treatments as disclosed in this invention.

Oiling out refers to the undesirable separation of oil from a dough matrix during processing, particularly during mixing, extrusion, or die exit. Oiling out results in inconsistent dough flow, structural weakness, and degraded product quality.

Dough matrix refers to the composite structural network formed by flour particles, binders, water, and other components after mixing. The integrity of the dough matrix influences extrusion performance, shape retention, and final product characteristics.

Shelf-stable pasta refers to a dried pasta product that may be stored at ambient conditions for extended periods without spoilage or significant degradation in quality.

As set forth in the summary above and discussed in greater detail below, the present invention is an integrated nut-based pasta system with a number of inventive embodiments, with each having multiple features and aspects. These include the following.

### Composition of the Almond-Based Flour

The present invention provides an improved almond-based flour composition engineered specifically for use in pasta, extruded foods, and other structured gluten-free products. The flour composition exhibits enhanced hydration behavior, improved cohesiveness, and superior compatibility with binder systems and extrusion processes relative to conventional almond flours.

In certain embodiments, the improved almond-based flour comprises a mixture of almond flour, almond protein powder, tapioca starch, and optionally psyllium husk or other binding agents. The ingredients are processed individually or collectively through particle-size refinement techniques to achieve micron-scale or sub-micron-scale particle sizes, thereby creating a more uniform and functional flour system.

The primary ingredients are as follows.
Almond Flour: In certain embodiments, the composition includes almond flour in an amount ranging from approximately 30 percent to 80 percent by weight of the total flour mixture. Almond flour may be full-fat, partially defatted, or fully defatted, depending on desired dough characteristics and extrusion performance.
Almond Protein Powder: In certain embodiments, almond protein powder is included in an amount ranging from approximately 5 percent to 40 percent by weight. Almond protein powder contributes structural reinforcement, reduces oil content in the flour blend, and enhances the mechanical stability of the resulting dough matrix.
Tapioca Starch: In certain embodiments, tapioca starch is included in an amount ranging from approximately 5 percent to 25 percent by weight. Tapioca starch provides elasticity, contributes to gel formation during hydration, and improves the firmness and texture of cooked pasta.
Psyllium Husk (Pre-Refinement): In some embodiments, powdered psyllium husk is included in an amount ranging from approximately 0 percent to 10 percent by weight. Psyllium husk in powdered form may be refined along with the other dry ingredients, used in combination with the psyllium husk serum disclosed herein, or omitted in favor of serum-only binder systems.

In various embodiments, each of the foregoing ingredients is processed through one or more mechanical refinement techniques, including cryogenic grinding, jet milling, ball milling, or ultrasonic milling, to produce substantially uniform particles having average diameters of approximately 0.1 microns to 10 microns.

The resulting flour exhibits: (a) improved hydration uniformity; (b) enhanced binding interaction with serum-based binders; (c) reduced oil segregation within the dough; (d) increased cohesiveness during mixing and extrusion; (e) more uniform density and texture in finished pasta products.

Multi-Ingredient Refinement: In certain embodiments, the ingredients are refined individually prior to blending, refined collectively after blending, or refined using a hybrid approach, where some ingredients are processed separately and others together.

Collective refinement may be used to promote co-dispersion of almond flour, almond protein powder, and starch components, while individual refinement may be preferred for ingredients with different hardness, oil content, or milling characteristics.

Optional Additives: In additional embodiments, the almond-based flour includes one or more optional functional additives such as plant proteins (pea, sunflower, chickpea, fava bean); dietary fibers; hydrocolloids; resistant starches; natural or modified starches; and mineral fortification agents. Such additives may be included in amounts ranging from approximately 0.1 percent to 15 percent by weight, provided they do not materially alter the gluten-free nature of the composition.

Alternative Nut-Based Flour Systems: In certain embodiments, the almond-based flour may be combined with, replaced by, or supplemented with flour derived from other nuts, including hazelnut, pistachio, cashew, walnut, macadamia, pecan, pine nut, and/or chestnut. These alternative flours may undergo the same particle-size refinement processes and may be used individually or in combination with almond-based ingredients.

The improved almond-based flour compositions disclosed herein provide at least the following functional advantages: (a) reduced brittleness and enhanced tensile strength in the dough matrix; (b) increased elasticity enabling formation and retention of pasta shapes; (c) improved extrusion stability and reduced oiling out; (d) enhanced cooking performance including improved bite and surface uniformity; and (e) compatibility with psyllium serum, which integrates more effectively with micronized ingredients than with coarse or heterogeneous flours.

The refined flour compositions serve as a foundational component of the dough systems, binder integration strategies, extrusion methods, and pasta products described in subsequent sections.

### Particle Size Refinement (Nano-Technology Processing)

The present invention, in certain embodiments, is a particle-size refinement process, also referred to herein as nano-technology processing, nano-refinement, or micronization, configured to reduce the particle size of almond flour, almond protein powder, tapioca starch, psyllium husk (optional), and other functional components to micron- and sub-micron-scale dimensions. This refinement process significantly enhances the ingredient interactions, hydration dynamics, and structural cohesion of the dough, resulting in superior mechanical, rheological, and sensory characteristics in the finished pasta products.

Conventional almond-based and nut-based flours exhibit broad, heterogeneous particle-size distributions that impede uniform hydration and inhibit the formation of cohesive dough matrices.

By refining particles to controlled micron- or sub-micron-scale ranges, the present invention achieves the following benefits: (1) improved surface area and hydration efficiency, enhancing water absorption and enabling formation of a uniform, stable dough matrix; (2) enhanced binding interaction, particularly with the psyllium husk serum described herein, due to increased surface contact and dispersion; (3) reduced oiling out, as finely milled particles distribute natural lipids more evenly within the dough, reducing localized lubrication and structural weakness; (4) improved dough cohesion and elasticity, enabling formation of continuous extrudates with minimal breakage; and (5) superior texture in the final products, providing smoother surfaces, improved density, and desirable bite characteristics.

In various embodiments, the particle-size refinement process is achieved through one or more of the following high-precision mechanical techniques: (a) cryogenic grinding; (b) jet milling; (c) ball milling; and (d) ultrasonic milling or cavitation processing.

Cryogenic Grinding: In certain embodiments, almond flour, almond protein powder, tapioca starch, or combinations thereof are cooled to low temperatures using liquid nitrogen or other cryogenic media prior to or during milling. Cryogenic grinding reduces heat generation during milling, minimizes oil release from almond-based ingredients, produces brittle particles conducive to fine size reduction, and preserves nutritional and functional properties that might degrade under thermal stress.

Jet Milling: In certain embodiments, particles are accelerated in an air or inert-gas stream and collide at high velocity, fracturing into finer particles. Jet milling enables precise and narrow particle-size distribution without mechanical grinding surfaces that might induce heat or contamination.

Ball Milling: In certain embodiments, particles are placed in a chamber with ceramic, metal, or composite milling media. Controlled agitation produces uniform mechanical impact and shear forces that reduce particles to micron- or sub-micron-scale sizes. Ball milling is particularly effective for achieving refinement of protein and starch fractions.

Ultrasonic Milling or Cavitation Processing: ultrasonic energy may be applied to slurries or hydrated particle systems prior to drying. Cavitation forces generated by high-frequency sound waves can break down agglomerates, reduce particle size, and enhance dispersion uniformity.

Hybrid and Multi-Stage Milling Systems: In yet further embodiments, combinations of the above processes are employed sequentially or simultaneously. For example: (1) cryogenic grinding followed by jet milling to achieve ultra-fine powders; (2) ball milling followed by ultrasonic processing to break down remaining aggregates; (3) jet milling followed by sieving or air classification to achieve ultra-narrow particle-size distributions, These combinations enable tailored refinement for different ingredient types. Other exemplary hybrid and/or multi-stage milling systems/processes/techniques may be employed.

In accordance with certain embodiments of the present invention, the particle-size refinement process produces ingredients having average particle sizes of approximately 0.1 microns to 10 microns. In other embodiments, the particle-size refinement process produces ingredients having average particle sizes of approximately 0.5 microns to 5 microns, In yet other embodiments, the processes provide a narrow particle-size distribution, with at least 80 percent of particles falling within ±20 percent of the mean size. Such particle-size characteristics beneficially enable uniform hydration, consistent dough development, and improved rheological stability during extrusion.

In certain embodiments, each ingredient—almond flour, almond protein powder, tapioca starch, and optional psyllium—is refined independently to account for differences in hardness, oil content, or thermal sensitivity.

In other embodiments, a premix of ingredients is refined together. This approach promotes co-dispersion and ingredient integration at the particle level, resulting in more uniform dough matrices.

In certain embodiments, the protein or starch fractions are refined individually and the almond flour is refined together with other components. The hybrid embodiments balance processing efficiency with ingredient performance optimization.

After milling, the refined particles in certain embodiments undergo one or more of the following: (1) sieving or air classification to remove oversized particles; (2) blending to homogenize multi-ingredient compositions; (3) agglomeration control to maintain free-flowing powder characteristics; and (4) storage under controlled humidity to prevent clumping. In certain embodiments, the ingredients undergo all these steps.

In certain embodiments, powders may be packaged immediately for distribution as a refined flour product or used directly in dough preparation.

The nano-refined ingredients produced in accordance with the various embodiments of the present invention demonstrate superior interaction with the psyllium husk serum described herein. When combined during dough preparation: hydration occurs more evenly; the serum binds more uniformly to particle surfaces; dough cohesion and elasticity increase; and oiling out during mixing and extrusion is significantly reduced. These synergistic effects yield dough matrices uniquely suited for gluten-free pasta manufacturing.

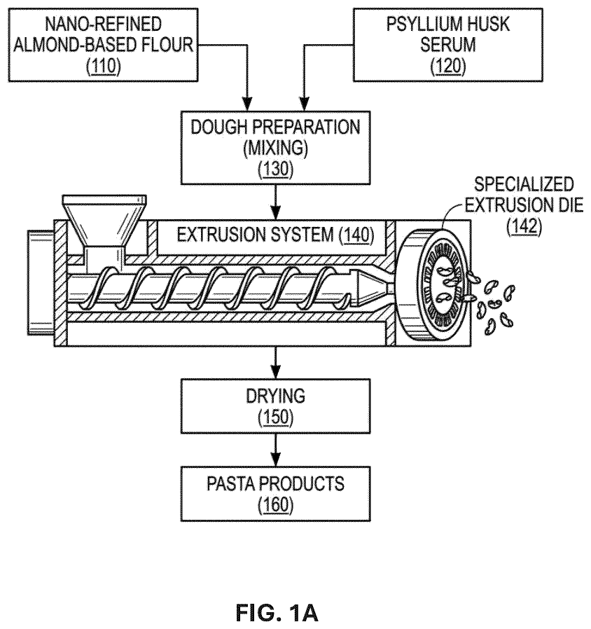

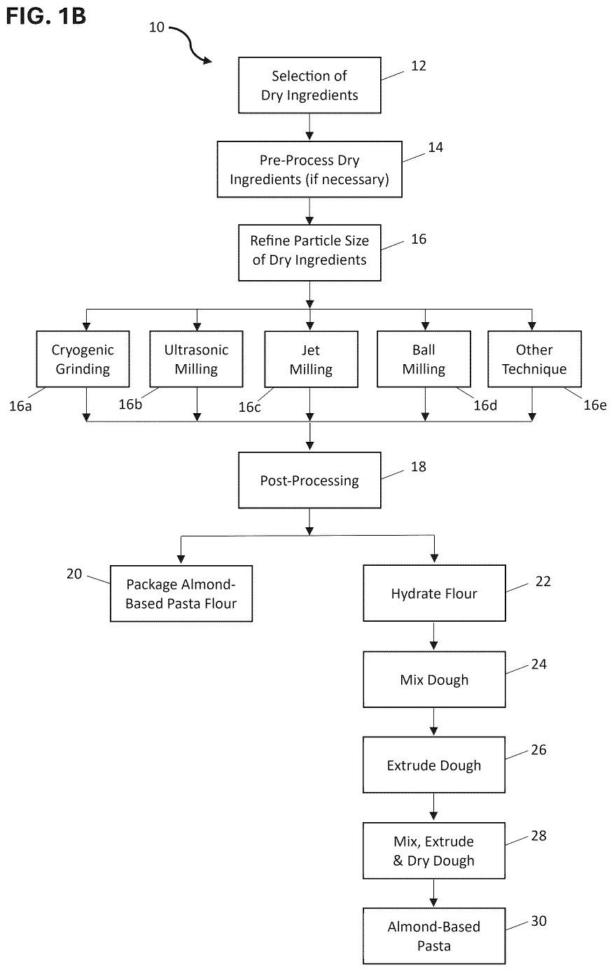

Referring to FIG. 1A of the drawings, a flow diagram of the process for producing pasta products in accordance with certain embodiments of the present invention is shown. In particular, in such certain embodiments, nano-refined almond-based flour is produced (110) as described herein, and psyllium husk serum (120) is produced also as described herein (including as described below). The nano-refined almond-based flour and the psyllium husk serum are combined and mixed (130) to prepare the dough and the prepared dough is fed into extrusion system (140) that utilizes a specialized extrusion die (142) to extrude the pasta in a desired shape(s). Extrusion and the extrusion die, and variations thereof, are further discussed below. The extruded pasta then is dried (150) to produce pasta products (160), as further described herein.

FIG. 1B shows another flow diagram, in accordance with select embodiments, of the inventive process of manufacturing the inventive flour and pasta.

The manufacturing process 10 of the present invention starts with the selection of the ingredients (12). In certain embodiments, the ingredients are comprised of only almond flour, almond protein powder, tapioca starch, and psyllium husk, with each ingredient procured as dry powders. In certain further embodiments, psyllium serum is introduced into the almond-based pasta dough during the mixing stage, replacing or complementing the psyllium husk dry powder in the formulation. In a further embodiment, psyllium husk dry powder is included in the original mix and psyllium serum is added during the mixing stage. In an alternative embodiment, psyllium husk dry powder is not included in the formulation and psyllium serum is added during the mixing stage. These various embodiments are described further below.

Each of the ingredients can be obtained in high quality form from suitable suppliers. But, if necessary, any of the dry ingredients can be processed, or pre-processed, in manners well known in the art (14), such as, if necessary, cleaning, conditioning, grinding/milling, sifting and other processes or subprocesses/preprocessing that are employed within the flour manufacturing field. Since such processes/subprocesses/preprocessing are well known, further details are omitted herein except where necessary for an understanding of the present invention.

In accordance with the present invention, the ingredients undergo particle size refinement (16), as herein described. In one embodiment or version, cryogenic grinding (16a) is employed while preserving the particles'chemical integrity, such as its essential oil, aroma, and color, among other characteristics. Cryogenic grinding, by increasing the ingredients brittleness (due to the cooling), results in finer particle sizes and more uniform particle distribution, and further reduces oxidation (otherwise caused during grinding) thereby extending shelf life. In another embodiment, each dry ingredient undergoes ball milling (16b) to achieve near micron or sub-micron particle size. In a further embodiment, each dry ingredient undergoes jet milling (16c). In a fourth embodiment, each dry ingredient undergoes ultrasonic milling (16d).

In each mechanical particle refinement process, the size of the particles is extremely well controlled due to each technique's high precision. In some processes, particle size is controlled down to the nanometer range (i.e., 0.001 micron). Moreover, each technique beneficially generates only minimal heat as compared to other techniques that reduce particle size. The techniques also reduce particle size with minimal contamination. However, the present invention is not limited to reducing particle size exclusively by employing these four techniques and, accordingly, one or more other known mechanical techniques that suitable reduce the size of the ingredients mentioned herein may be employed within the present invention (16e).

Moreover, in certain embodiments, different particle size refinement techniques may be employed for different ingredients. For instance, one or more of the dry ingredients (but not all of the dry ingredients) undergo cryogenic grinding to reduce particle size, and the other dry ingredient(s) undergoes ultrasonic milling. In yet other embodiments, one or more of the dry ingredients undergo multiple particle size refinement techniques. These are exemplary.

In accordance with the present invention, as set forth in certain embodiments, the particle refinement process is controlled to achieve an average particle size of each ingredient of less than 10 microns. In select embodiments, the average particle size after refinement is in the range of 0.5 to 5 microns. In yet other select embodiments, the average particle size after refinement is below 1 micron. In yet further select embodiments, the different ingredients are refined to different sizes.

The refined ingredients are sieved, combined in specified proportions, and blended during post-processing (18) to ensure uniform particle size distribution to produce the inventive almond-based pasta flour. Finally, the almond-based pasta flour is packaged for distribution and sale (20).

Rather than combine the ingredients (in step 18), in other embodiments, each ingredient is separately packaged for subsequent use, distribution and/or sale. Thereafter, the ingredients at a later date are combined in appropriate proportions and blended to produce the inventive almond-based pasta flour. In yet a further embodiment, the dry ingredients are combined in appropriate proportions prior to particle refinement (16) and then the combined ingredients are collectively refined in size and subsequently processed, and then packaged (20).

In further embodiments, the pasta flour is directly used in the dough formulation/pasta manufacturing process. In particular, the refined powders are combined in specified proportions (if not already combined) and hydrated (22) as described further herein.

The dough then undergoes mixing (24) in suitable commercial equipment and extruded through an appropriate die (26) to produce the raw pasta noodles. In additional embodiments of the invention, an inventive die is employed. In other embodiments, other suitable dies may be employed. Finally, the pasta is dried (28) using conventional techniques to produce the inventive shelf-stable almond-based pasta (30).

In accordance with the present invention, the inventive techniques described herein result in enhanced binding capabilities due to increased surface area interaction as a result of the near-micron size, and in certain embodiments, sub-micron size of the ingredients. This in turn avoids or at least substantially reduces the need to introduce additional binders within the formulation. The present invention in certain embodiments employs additional binders. The refined particles further enhance texture by exhibiting a smoother, more uniform texture, closely resembling traditional wheat-based pasta. The enhanced cohesiveness of the dough also improves structural integrity by reducing the likelihood of cracking or breaking during the extrusion and drying processes, which in turn improves yield and reduces waste.

In still yet further embodiments, other types of nuts may be used in place of almonds. In particular, nuts that have similar characteristics as almonds include hazelnuts, macadamia nuts, pecans, cashews, walnuts, pistachios, pecans, pine nuts, and chestnuts. Accordingly, in various alternative embodiments, anyone of these types of nuts are used in place of almonds in the various embodiments described herein. Still yet, other types of nuts, even with different characteristics, may be employed within the present invention. Hence, the invention includes the following: hazelnut-based pasta flour and hazelnut-based pasta; macadamia nut-based pasta flour and macadamia nut-based pasta; pecan-based pasta flour and pecan-based pasta; cashew-based pasta flour and cashew-based pasta; walnut-based pasta flour and walnut-based pasta; pistachio-based pasta flour and pistachio-based pasta; pecan-based pasta flour and pecan-based pasta; pine nut-based pasta flour and pine nut-based pasta; chestnut-based pasta flour and chestnut-based pasta; and peanut-based pasta flour and peanut-based pasta (although peanut is technically not a “nut”). Other nuts may be employed as well. The present invention includes methods of manufacturing any and all of the foregoing flour and pasta products.

In yet other additional embodiments, the flour products described herein may be used to manufacture other types of products, such as bread, pastries, cakes, cookies, pancakes, dumplings, pizza, muffins, biscuits, doughnuts, pies, and other forms of baked goods. The flour products described herein are particularly well suited to manufacture extruded type products beyond pasta including snack foods (e.g., chips, crackers), breakfast cereals (e.g., flakes, puffed grains), confectionary products (e.g. chewing gum, licorice, toffee), among other products. In addition, the flour products described herein are extremely well suited to manufacture gluten-free versions of any and all of the products identified herein (i.e., without the need to introduce ingredients that contain gluten), and plant-based meat substitutes as appropriate.

The following are exemplary embodiments in accordance with the present invention. In a first example, almond flour is cryogenically grinded to an average particle size of 5 microns to produce dough with improved elasticity and smoother extrusion properties in accordance with the various embodiments described herein. In a second example, jet milling of tapioca starch and almond protein powder, followed by ultrasonic blending with psyllium husk, achieves a uniform mixture that hydrates evenly and produces a superior pasta texture in accordance with the present invention. These are just two additional examples as provided herein out of countless examples given the description herein.

As appreciated from the description herein, the present invention introduces novel techniques to overcome difficult challenges in utilizing nuts to produce flour that are well suited in the manufacture of nut-based pasta. Accordingly, in brief summary, the present invention pertains to mechanically reducing the particle size of generally off-the-shelf ingredients, including almond flour, almond protein powder, tapioca starch, and psyllium husk, to near micron, micron, and sub-micron dimensions. Such refinement enables improved dispersion of particles, superior binding, and enhanced dough elasticity. When incorporated into the pasta manufacturing process, the refined particles result in a more cohesive dough, reduce structural inconsistencies, and produce pasta with a superior texture and mouthfeel.

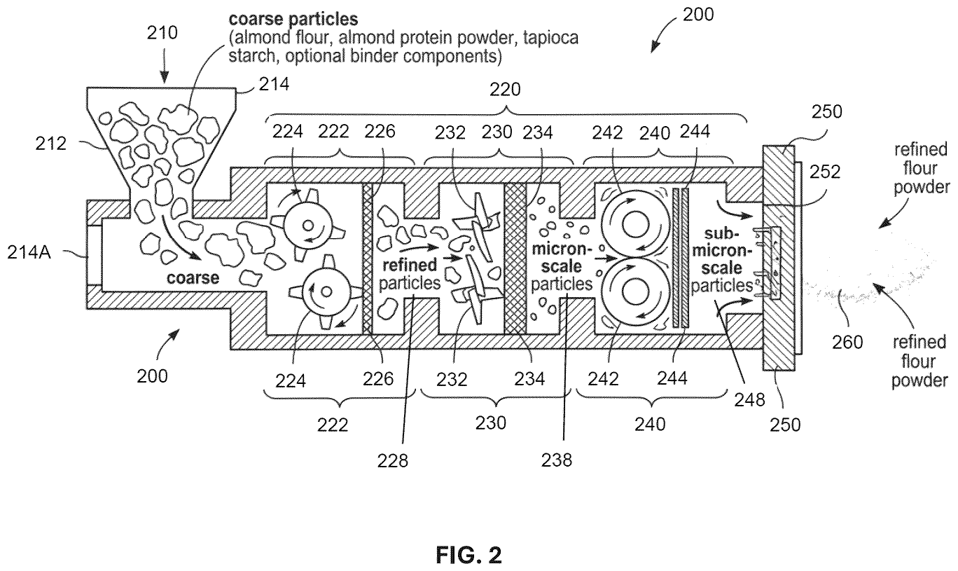

For illustrative purposes, FIG. 2 of the drawings shows a schematic, graphical representation of particle-size refinement in accordance with certain embodiments of the present invention. As illustrated, each of the ingredients undergo progressive reduction in size from coarse particles to the micron- and sub-micron-scale using one or more mechanical milling techniques. For instance, as shown in FIG. 2, course particles 210 of the ingredients, including, for example, almond flour, almond protein powder, tapioca starch, and the optional binder components, are fed into the illustrated pasta extrusion die assembly 200 via inlet 214 of hopper 212 (or via alternative inlet 214A).

The course particles enter the milling section 220 that is comprised of, in certain embodiments, three milling substages 222, 230, and 240. The course particles initially enter the first milling substage 222 that carries out cryogenic grinding via the cryogenic milling rotors/agitators 224 and rotary screen 226 that mix, cool, and grind the particles under cryogenic conditions to produce refined particles 228.

The refined particles then undergo further refinement in the second milling substage 230, which in the illustrative drawing, includes angled blades 232 and an ultrasonic sonotrode array 234 to produce micron-scale particles 238. These particles then enter the final milling substage 240 that includes, in the illustrated embodiment, opposed-jet nozzles 242 and a dynamic air classifier wheel 244 that produce the sub-micron scale particles 248.

It is appreciated that the various milling substages may vary from that shown in FIG. 2, and that the number of substages may be different. For instance, there may be one, two, four, or more substages.

In accordance with the present invention, the sub-micron scale particles are forced through die plate 250, via port 252, that extrudes the refined flour powder 260.

As discussed, the ingredients can undergo particle size refinement using any suitable technique including one or more of the techniques described herein. As described, the refined particles are processed in accordance with any of the methodologies described herein, for instance, in accordance with that shown in FIG. 1A and/or FIG. 1B, or other disclosed methodology, to produce the inventive pasta flour.

### Psyllium Husk Serum and Method for Producing a Psyllium Husk Serum

The present invention in certain embodiments provides a novel psyllium husk serum, which functions as an improved binding system for almond-based and other nut-based doughs. The psyllium husk serum exhibits markedly enhanced hydration uniformity, binding efficiency, and dough integration compared to conventional psyllium husk powder. Through controlled hydration and mechanical refinement, psyllium is transformed from a coarse, fibrous powder into a smooth, serum-like material capable of forming continuous gel networks throughout the dough matrix.

Conventional psyllium husk powder absorbs water rapidly but inconsistently, forming localized clumps and uneven gel structures. These characteristics limit its effectiveness in gluten-free dough systems, particularly those containing high lipid levels such as almond flour.

The psyllium husk serum of the present invention provides: (a) uniform hydration and dispersion, eliminating clumping associated with powdered psyllium; (b) improved interaction with nano-refined particles, due to increased surface contact and gel uniformity; (c) enhanced dough elasticity and cohesiveness, supporting structural formation in the absence of gluten; and (d) reduced brittleness and improved extrusion stability in high-oil dough systems.

In certain embodiments, the psyllium husk serum is prepared by hydrating psyllium husk powder in water under controlled conditions. The process includes the following steps.
Step 1: Hydration of Psyllium Husk: Psyllium husk powder is combined with water in a controlled ratio. In certain embodiments, the ratio ranges from 1 part psyllium husk to 10-25 parts water by weight, water may be supplied at room temperature or at an elevated temperature (e.g., 40° C. to 60° C.) to accelerate gel formation, and the mixture is allowed to hydrate for a duration sufficient to initiate mucilage release and preliminary gel formation.
Step 2: Mechanical Refinement: after hydration, the psyllium mixture undergoes mechanical processing to break down fibrous structures and eliminate clumping. In various embodiments, this may include one or more of the following: (a) high-shear mixing using rotor-stator devices or industrial blenders; (b) homogenization, including high-pressure homogenization; (c) ultrasonic cavitation, which uses high-frequency sound waves to disrupt gel aggregates; and (d) colloid milling, which emulsifies and shears hydrated particles. The result is a smooth, continuous, gel-like medium referred to herein as the psyllium husk serum.
Step 3: Optional Refinement or Adjustment: In certain embodiments, the serum undergoes additional processing, including: (a) particle-size refinement to further reduce gel microstructures; (b) chemical adjustment, such as mild acidification (e.g., citric acid) to modulate viscosity; the addition of food-grade salts (e.g., sodium chloride) to influence ionic interactions, and/or thermal conditioning to adjust serum rheology. Adjustments allow fine-tuning of the serum's viscosity and gel strength to match desired dough characteristics.

The resulting psyllium husk serum exhibits the following qualities: (a) smooth, homogeneous consistency lacking dry clumps or partially hydrated fragments; (b) viscosity levels suitable for uniform integration into gluten-free dough systems; (c) particle-size distribution below approximately 50 microns (in certain embodiments), enabling enhanced dispersion; and (d) improved water retention, contributing to dough elasticity and reduced breakage.

These properties distinguish the serum from powdered psyllium and enhance its compatibility with refined almond-based flour compositions.

Incorporation into Dough: In select embodiments, the psyllium husk serum is incorporated into the dough during the mixing or hydration stage. The serum may replace powdered psyllium entirely, or supplement powdered psyllium, enhancing overall binding characteristics.

Serum incorporation provides: (1) continuous gel networks throughout the dough; (2) enhanced cohesiveness and workability; (3) improved extrusion performance; and (4) more uniform drying and reduced brittleness.

The psyllium husk serum offers several technical advantages, including: (1) elimination of powder-induced clumping; (2) uniform hydration across the dough matrix; (3) smoother, more continuous gel structures; (4) enhanced binding and elasticity in high-fat doughs; (5) better integration with micronized flour components; and (6) reduced variability and improved batch-to-batch consistency. These advantages make the psyllium husk serum uniquely suited for the manufacture of almond-based and other nut-based pasta products.

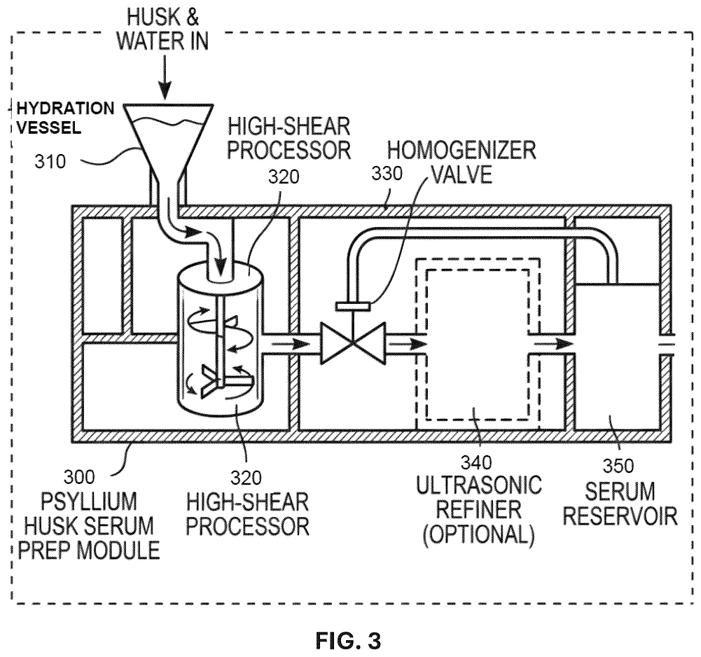

FIG. 3 is a schematic illustration of an exemplary psyllium husk serum preparation module 300 in accordance with the present invention. As illustrated, psyllium husk in the form of powder is combined with water within hydration vessel 310 (or another suitable vessel) in manners described herein.

The hydrated husk undergoes mechanical processing within a high-shear processor 320 that breaks down the fibrous structures of the husk. As discussed, other methodologies and equipment may be employed for this function. The hydrated husk then proceeds through a homogenizer valve and then proceeds through an ultrasonic refiner 340 to disrupt gel aggregates before being received within a serum reservoir 350. In certain embodiments, the ultrasonic refiner is omitted. In other embodiments, the serum enters a further subsystem to emulsify and shear the hydrated particles. In yet other embodiments, the system includes further subsystems for carrying out further refinements and/or adjustments, as discussed herein.

In still other embodiments, the serum undergoes chemical adjustment during which the viscosity of the psyllium serum is modified by introducing into the gel food-grade acids, bases, or salts (e.g., citric acid or sodium chloride) in trace amounts to alter the molecular interactions within the gel.

The various embodiments described result in a final serum that exhibits a smooth, viscous consistency with a particle size distribution smaller than 50 microns that, in turn, ensures homogeneity and ease of incorporation into dough formulations.

With such novel psyllium husk serum, in accordance with any of the various embodiments described herein, such serum is introduced into the almond-based pasta dough (and other nut-based pasta doughs) during the mixing stage of the pasta manufacturing process (e.g., step 24 in FIG. 1B). In certain embodiments, the psyllium husk serum completely replaces the psyllium husk powder. That is, psyllium husk powder is not included within the inventive flour that is produced from the herein-described processes. In certain other embodiments, however, the psyllium husk serum is added during the pasta dough mixing stage along with the inclusion of psyllium husk powder within the flour. The serum enhances water binding, ingredient cohesion, and dough elasticity, and results in an even greater uniform and pliable dough.

Once added during the mixing stage, the remaining pasta manufacturing steps as described herein are carried out to produce the inventive pasta.

In accordance with such embodiments of the present invention, the serum-like consistency of psyllium that is introduced into the formulation during pasta manufacturing enhances the dough's ability to bind the dry ingredients uniformly. The serum further facilitates better hydration and distribution of the ingredients, that in turn results in a more elastic dough that is easier to extrude and shape. Moreover, pasta made in accordance with the embodiments employing the psyllium serum exhibits a smoother surface, improved bite, and reduced brittleness as compared to formulations that use only powdered psyllium.

In addition to almond-based pasta, as described in detail herein, the inventive psyllium serum can be utilized within other manufacturing processes to produce other nut-based pastas, as well as other products, such as all of the products mentioned above, including other high-moisture extruded products.

Exemplary embodiments in accordance with the invention include a psyllium serum prepared by hydrating psyllium husk in a 1:15 ratio with warm water and homogenizing for 5 minutes produces a smooth serum that, when used in almond-based pasta dough, reduces breakage during extrusion and drying. In another example, a psyllium serum enhanced with a 0.05% citric acid solution produces a lower viscosity, which improves dough handling and results in a softer texture in the finished pasta.

As described, the invention introduces a novel transformation of psyllium husk powder into a serum-like substance, enhancing its functionality as a binding agent in almond-based pasta, other nut-based pasta, and other food products identified herein. As a brief summary of certain embodiments of the invention, psyllium husk powder is converted into a serum-like substance through hydration and controlled mechanical manipulation as described herein to provide enhanced binding characteristics in almond and other nut based dough, including pasta dough, along with improved dough elasticity and texture of the final product.

### Dough Preparation and Hydration

The present invention further provides improved methods for preparing dough compositions comprising the nano-refined almond-based flour, psyllium husk serum, water, and optional additives. The disclosed dough preparation methods yield uniform, cohesive, and elastic dough matrices that withstand the mechanical, thermal, and shear stresses associated with gluten-free pasta manufacturing, particularly extrusion.

Overview of Dough Formation: The dough preparation process generally involves: (1) combining nano-refined dry ingredients; (2) incorporating the psyllium husk serum; (3) adding water under controlled hydration conditions; and (4) mixing the dough to develop structural integrity.

These steps may be carried out using conventional commercial mixing equipment, such as ribbon blenders, planetary mixers, horizontal mixers, or auger-based hydration systems. Batch size and processing duration may be adjusted to maintain consistent dough properties across production runs.

In certain embodiments, all nano-refined dry ingredients—almond flour, almond protein powder, tapioca starch, and optional binders or functional additives—are introduced into a mixing vessel and blended until uniformly dispersed. Uniform pre-blending of dry ingredients: (a) prevents localized concentration of any component; (b) ensures consistent hydration kinetics; and (c) promotes even serum distribution during subsequent mixing stages.

In certain embodiments, prior to dry blending, one or more of the dry ingredients—including almond flour, almond protein powder, and tapioca starch—are pre-sifted or screened through a mesh, sieve, or air-classification system. Pre-sifting removes agglomerates and oversized particles and promotes a more uniform particle distribution prior to mixing. This step improves downstream mixing efficiency, reduces localized clumping during hydration, and enhances uniform interaction between the nano-refined particles and the psyllium husk serum during dough formation.

Following blending of the dry ingredients, the psyllium husk serum is introduced into the mixture. The serum may be added gradually, to ensure uniform coating of refined particles, or continuously, via pumping or metered addition systems during mixing.

Because the serum is pre-hydrated and mechanically processed, it disperses efficiently throughout the dough, creating continuous gel-like networks that enhance cohesion, improve elasticity, mitigate brittleness, and reduce oil separation under shear.

In certain embodiments, the serum replaces powdered psyllium entirely; in other embodiments, the serum is used in combination with powdered psyllium to modulate binding characteristics.

Water is incorporated into the dough mixture using controlled hydration techniques. In various embodiments: (1) water temperature ranges from ambient to 40-60° C., depending on desired hydration behavior; (2) total dough hydration levels range from 20 percent to 50 percent by weight, depending on flour composition and particle-size characteristics; and (3) water may be added in one or more stages to modulate viscosity, binder activation, and dough development.

Gradual water addition is preferred to prevent oversaturation and to allow uniform hydration of the micronized particles.

Mixing Parameters and Dough Development: In certain embodiments, dough preparation is performed using controlled batch sizes selected to maintain consistent mixing, hydration, and thermal conditions. Smaller or shorter-duration batches may be employed to reduce variability associated with prolonged mixing times, heat buildup, or ingredient segregation. Controlled batch sizing improves dough uniformity, extrusion consistency, and finished pasta quality, particularly for gluten-free, high-oil formulations.

The dough is mixed until a cohesive, malleable matrix forms. In certain embodiments: (1) mixing times range from 2 minutes to 20 minutes, depending on equipment and batch size; (2) mixing speeds and shear conditions are adjusted to ensure ingredient integration without overheating the dough; and (3) mixing continues until the dough exhibits a uniform texture and stable structural properties suitable for extrusion.

Proper dough development is characterized by sufficient elasticity to form continuous extrudates, absence of dry pockets or partially hydrated clusters, uniform distribution of serum and refined particles, and minimal surface oiling during handling.

Rheological characteristics of the prepared dough: Dough prepared in accordance with the present invention exhibits rheological properties that differ substantially from conventional almond-based doughs. These include: (1) increased cohesiveness, enabling the dough to remain intact under shear stress; (2) controlled viscosity, allowing stable flow through extrusion dies; (3) elastic recovery, facilitating dimensional stability of pasta shapes; and (4) resistance to oiling out, even during high-pressure extrusion. These improved properties arise from the synergistic interaction of the nano-refined flour composition and the psyllium husk serum binder system.

In some embodiments, the dough is allowed to rest for a defined period (e.g., 5-20 minutes) to complete hydration of micronized particles, allow the serum to fully interact with the flour matrix, and stabilize dough viscosity prior to extrusion.

Compatibility with Various Extrusion Systems: The dough produced via this process is compatible with auger-driven pasta extruders, piston extruders, cold extrusion systems, and high-shear continuous extrusion systems.

Its stability and reduced sensitivity to sheer variations make it particularly suited to the improved extrusion die discussed in further detail below.

### Specialized Extrusion Process/Dies

The present invention provides improved methods for extruding dough compositions formulated with the nano-refined almond-based flour and psyllium husk serum disclosed herein. The extrusion process is configured to shape the dough into pasta or other extruded food products while maintaining structural stability, minimizing oil separation, and preserving dimensional accuracy. The improved dough formulations and specialized extrusion die described in this application work together to overcome the limitations of conventional extrusion technologies when applied to high-oil, gluten-free dough systems.

Extrusion generally involves forcing dough through one or more die orifices under controlled pressure and shear. For gluten-free doughs—particularly nut-based doughs—extrusion performance is highly influenced by dough rheology, temperature, lubrication effects of natural oils, and die geometry.

In certain embodiments, the extrusion pathway includes a directional change such that the dough is extruded vertically rather than horizontally. In certain embodiments, the extrusion pathway includes an approximately 90-degree bend prior to the extrusion die, allowing the extrudate to exit the die in a downward, gravity-assisted orientation. Vertical extrusion reduces gravitational bending, sagging, and deformation of freshly extruded gluten-free pasta strands, particularly in high-oil dough systems with limited initial structural rigidity.

The methods/structures disclosed herein enable: (a) continuous, stable dough flow; (b) reduced die fouling and clogging; (c) minimized oiling out; (d) consistent formation of complex shapes; and (e) enhanced surface smoothness and density.

In certain embodiments, dough prepared according to structures/processes disclosed herein is delivered to the extrusion chamber using auger-based feed systems, vacuum-assisted feed systems, or gravity-fed mechanisms. Prior to extrusion, the dough may undergo gentle kneading or pressurization to remove air pockets and ensure homogeneous consistency.

Dough temperature is maintained within a controlled range (e.g., 15-35° C.) to optimize flow properties and prevent premature softening or oil release.

Extrusion Equipment Compatibility: the dough formulations disclosed herein are compatible with several types of extrusion equipment, including but not limited to: (a) single-screw extruders; (b) twin-screw extruders; (c) cold extrusion pasta presses; and (d) high-shear or continuous-feed extruders. Because of the dough's improved elasticity and reduced oil separation, extrusion systems require fewer mechanical adjustments to maintain continuous flow.

During extrusion, the dough is subjected to pressures sufficient to form continuous, dimensionally stable strands or shapes. In certain embodiments, typical extrusion pressures may range from 50 psi to 2,000 psi, depending on equipment design and pasta shape. Shear rates within the extrusion chamber are controlled to prevent overheating, which can exacerbate oil separation in nut-based doughs. The nano-refined particle structure and serum-based binding enable the dough to withstand these forces without fracturing, collapsing, or releasing excessive oil.

Interaction with the Improved Extrusion Die: As described further below, the inventive extrusion die includes optimized flow channels, tapered geometries, and surface treatments that: (a) reduce friction between the dough and die surfaces; (b) stabilize internal pressure distribution; (c) minimize shear-induced heating; (d) promote uniform extrusion velocities across the die face; and (e) prevent or greatly reduce oiling out. These features enhance the ability of the dough to form well-defined pasta shapes, including hollow or textured shapes that would otherwise collapse in high-oil dough systems.

The extruded dough exits the die as a continuous strand or shape, depending on die configuration. Shapes may include long extruded shapes (e.g., spaghetti, linguine), short extruded shapes (e.g., penne, rigatoni, fusilli), specialty or custom shapes, and flat or sheeted structures for lasagna or ravioli applications. The dough retains its shape due to improved elasticity derived from nano-refined ingredients and serum-based binders.

After exiting the die, the extrudate may be cut to length using mechanical or wire cutters, deposited onto drying trays, conveyed to drying tunnels, and/or prepared for further shaping or post-processing. The improved cohesiveness of the dough reduces breakage during cutting and transfer.

Temperature and Shear Management: Because high-oil doughs are sensitive to heat, the extrusion process may include active cooling mechanisms (e.g., chilled extrusion barrels), reduced shear mixing zones, optimized rotational speeds, and careful control of dwell time within the extruder. The disclosed dough formulation and improved die reduce thermal load and offer greater tolerance to extrusion variations.

A major advantage of the disclosed process/structure is the significant reduction or elimination of oiling out during extrusion. This is achieved through: (a) uniform dispersion of natural oils within micronized flour particles; (b) binding interactions facilitated by the psyllium husk serum; (c) reduced friction and shear stress within the die; and (d) controlled temperature during extrusion. Reduced oiling out enhances both extrusion stability and the structural integrity of pasta shapes.

Extruded dough produced in accordance with the present invention exhibits: (a) smooth and uniform exterior surfaces; (b) high internal density; dimensional stability; (c) consistent cross-sectional geometry; (d) resistance to deformation during drying or cooking; (e) and improved mouthfeel and texture in the final product.

In additional embodiments, the extrusion process may include incorporation of vacuum-deaeration steps, addition of post-extrusion surface treatments (e.g., starch dusting), and/or use of co-extrusion techniques to produce multi-layered or filled shapes. These modifications may improve performance for specific pasta shapes or formulations.

### Improved Extrusion Die

The present invention provides an improved extrusion die specifically engineered for processing dough compositions that contain high levels of natural oils, such as almond-based and other nut-based doughs. Traditional pasta dies are optimized for wheat-based doughs possessing strong viscoelastic gluten networks and low lipid content. When applied to high-oil, gluten-free doughs, conventional dies cause excessive shear, thermal buildup, oil separation (“oiling out”), deformation of pasta shapes, and frequent clogging. The improved extrusion die disclosed herein addresses these deficiencies through specialized geometric, surface, and thermomechanical design features.

In certain embodiments, the improved extrusion die comprises: (1) one or more flow channels configured to transition dough from the extruder barrel to the final outlet orifice; (2) tapered or gradual transition zones designed to balance pressure and reduce shear; (3) shaping orifices configured to form the desired pasta geometry; (4) surface treatments applied to interior channel walls; (5) pressure-relief or flow-balancing features; and (6) optional temperature-modulation components such as cooling channels or insulating layers.

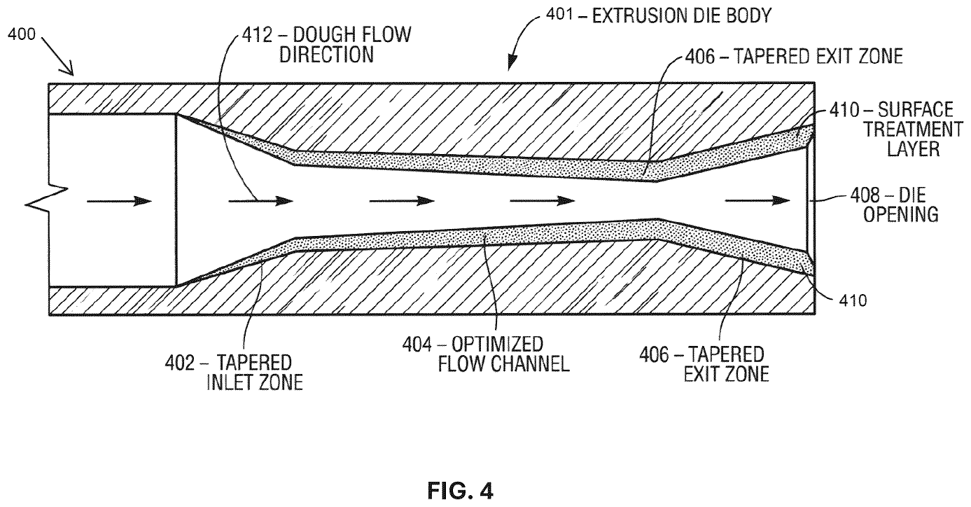

FIG. 4 is a cross-sectional illustration of an improved extrusion die 400 in accordance with certain embodiments of the present invention, featuring optimized flow-channel geometry, tapered transitions, and surface treatments configured to reduce shear stress, minimize oil separation, and enhance the stability of extruded high-oil doughs. As illustrated, the extrusion die 400 includes a body 401, a tapered inlet zone 402, a flow channel 404, a tapered exit zone 406, and a die opening 408. The die further includes a surface treatment layer 410. FIG. 4 also shows the dough flow direction 412. However, the inventive extrusion die may have structures that are different from that shown in FIG. 4, as would be appreciated by those of ordinary skill in the art.

In addition, the die may be formed from stainless steel, food-grade alloys, ceramic composites, or surface-engineered materials compatible with high-pressure food extrusion environments.

In accordance with the present invention, a key distinguishing feature of the improved extrusion die is the geometry of its internal flow channels. In various embodiments, internal channels include: (1) tapered converging sections that promote gradual compression of the dough and minimize abrupt shear that would otherwise disrupt high-oil matrices; (2) streamlined transition zones that avoid dead zones where dough may stagnate or overheat, thereby reducing clogging and inconsistencies; (3) balanced flow pathways, wherein for dies with multiple orifices, channels may be dimensioned to equalize pressure across all outlets, ensuring uniform shape formation; and (4) optimized length-to-diameter ratios, wherein the channels can be dimensioned to control residence time, flow velocity, and thermal load.

Moreover, to reduce dough adhesion, mitigate heat generation, and limit fouling, the improved extrusion die incorporate, in certain embodiments, one or more of the following: (1) electropolished surfaces, reducing microscopic asperities that trap dough particles; (2) non-stick coatings (e.g., PTFE-based or ceramic-based); (3) low-friction alloys or surface-engineered metals designed to reduce shear-induced heating; and (4) ceramic or composite inserts with inherently low thermal conductivity. These treatments are particularly advantageous for high-oil doughs, which tend to smear, adhere, and leak oil when extruded through untreated metal dies.

Pressure-Relief and Flow-Balancing Features: In various embodiments, the die includes structures configured to modulate internal pressure distribution, such as pressure-relief grooves, peripheral channels, micro-vent structures, or multi-stage compression zones. These features prevent pressure spikes that would otherwise cause dough tearing, oiling out, or deformation of extruded shapes.

High-oil doughs are particularly sensitive to temperature fluctuations during extrusion. Excessive heat may cause oil migration and separation, dough softening and collapse, irregular flow, or degradation of structural integrity.

To address this, in certain embodiments the die includes: (1) integrated cooling channels configured to circulate chilled water or coolant around the die body; (2) thermal insulation layers to minimize heat transfer from the extruder barrel; and (3) heat-dissipating fins or external geometric structures to reduce thermal accumulation. Collectively, these features help maintain extrusion temperatures within a range that preserves dough consistency.

The outlet orifices of the die may be configured to form a variety of pasta shapes, including cylindrical shapes (e.g., spaghetti, bucatini), tubular shapes (e.g., penne, rigatoni), helical or twisted shapes (e.g., fusilli), and sheet-like extrudates for lasagna or layered applications. Precise geometric definition is supported by the die's reduced back-pressure variance, lower friction, and improved dough cohesion.

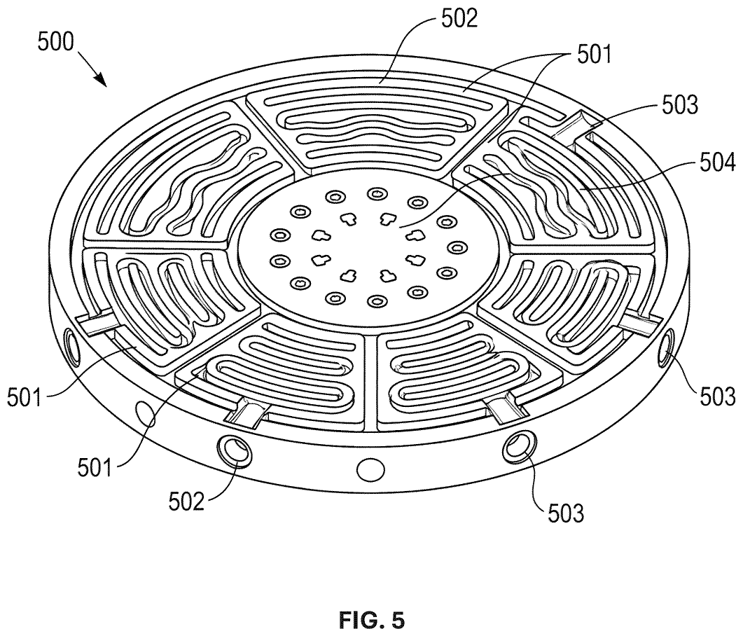

FIG. 5 is an isometric view of the inventive extrusion die, in accordance with certain embodiments. As shown, the die 500 includes radial flow distribution channels 501, pressure-relief groove regions 502, peripheral thermal management ports 503, and sector partition walls 504.

The radial flow distribution channels 501 extend outwardly from the central inlet region of the extrusion die and are configured to divide and route the dough uniformly across multiple circumferential sectors of the die body. In accordance with the invention, by distributing the dough evenly before it reaches the pressure-relief grooves and extrusion orifices, the channels 501 reduce localized pressure spikes, promote balanced flow paths, and improve extrusion uniformity. This is particularly beneficial for high-oil, nut-based doughs, which are prone to flow instability and oil separation under uneven shear conditions.

The pressure-relief groove regions (or pressure-equalization grooves) 502 comprise elongated, serpentine or curved recesses formed within each sector of the die and positioned downstream of the radial flow distribution channels. These grooves act as controlled expansion zones that reduce shear stress and equalize internal pressure across the die face. In the context of almond-based and other high-lipid doughs, the pressure-relief groove regions 502 significantly reduce “oiling out,” prevent premature fat separation, and enhance dough cohesion as it approaches the extrusion apertures.

The peripheral thermal management ports (or cooling channels) 503 are formed along the outer circumference of the die body and are configured to receive a cooling medium, thermal insert, or heat-dissipation structure. By regulating die temperature during extrusion, the ports 503 mitigate heat buildup caused by friction and shear forces. Thermal stabilization is critical for nut-based doughs, as excessive heat accelerates oil migration and dough degradation. The ports therefore contribute to consistent extrusion performance, improved surface finish, and extended operational run times.

The sector partition walls (or flow-balancing ribs) 504 define discrete flow sectors within the die and physically separate adjacent pressure-relief groove regions and radial flow paths. These partition walls prevent crossflow interference between neighboring sectors, ensuring that dough pressure and velocity remain balanced throughout the die. This structural segmentation enhances dimensional consistency of the extruded pasta, reduces turbulence, and supports uniform extrusion across all die openings, even when processing doughs with varying oil content or viscosity.

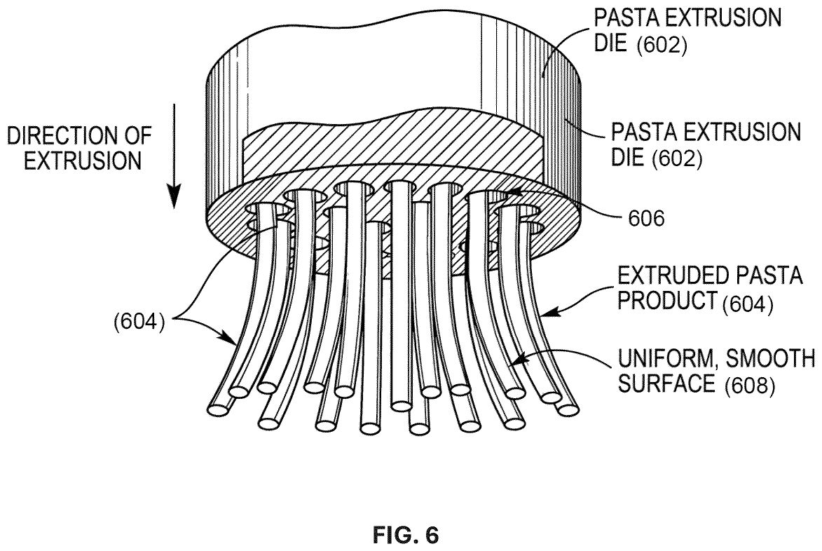

FIG. 6 is an exemplary perspective view that shows an exemplary pasta product (604) being produced using the compositions and methods disclosed herein, and particularly using the inventive extrusion die (602) described herein, illustrating the uniformity, smooth surface structure (608), and dimensional stability achieved by the invention, as the pasta emerges from the die orifices (606).

In certain embodiments, the extrusion die is configured for use in vertical or gravity-assisted extrusion systems, including systems incorporating angled or orthogonal flow paths that redirect dough flow prior to extrusion. The improved die may be configured to interface with single-screw systems, twin-screw extruders, cold extrusion pasta presses, and industrial-scale continuous extrusion systems. Retrofit compatibility is enabled through standardized mounting patterns and modular design options.

The improved extrusion die significantly reduces or prevents oil separation during extrusion due to: (a) optimized geometry that minimizes shear and dead zones; (b) surface finishes that limit frictional heating; (c) balanced pressure distribution across the dough flow path; and (d) hydration and binding improvements derived from nano-refined flour and psyllium serum integration. As a result, extruded pasta maintains structural integrity, exhibits smoother surfaces, and avoids internal voids caused by oil migration.

In certain embodiments, the die may be manufactured using CNC machining, electrical discharge machining (EDM), metal additive manufacturing, and precision casting followed by finishing operations. In some embodiments, modular inserts or interchangeable components enable rapid shape changes or die maintenance.

The improved extrusion die, in certain embodiments, provides the following performance enhancements: uniform extrusion flow and reduced clogging, improved dimensional stability of pasta, enhanced ability to form complex shapes, reduced brittleness and breakage of extrudates, minimal oil leakage during processing, higher throughput and reduced downtime; and improved surface finish and consistency. These advantages, combined with the improved dough formulation, result in pasta products that closely resemble or surpass wheat-based pasta in structural and sensory quality.

For illustrative purposes, the following are specific exemplary embodiments in accordance with the invention. In a first example, a specialized die with a 5° tapered flow channel and polished exit orifices eliminates oiling out during extrusion of almond-only dough, enabling consistent noodle production. In a second example, a die featuring integrated cooling channels and non-stick coatings facilitates the extrusion of high-oil dough without clogging or adhesion issues.

In brief summary, the inventive die of the present invention provides a novel solution to the challenges of extruding high-oil-content doughs in almond-based pasta production and the production of other products from high-oil-content dough. Accordingly, the die of the present invention prevents or minimizes “oiling out” (i.e., oil seepage), which would occur when high oil content dough is forced through more conventional extrusion dies. Oiling out is the unwanted separation of oil from the solid material during or after extrusion, which in turn results in poor structural integrity of the dough. The present invention provides a novel die to prevent or minimize such oiling out as herein described. In addition, in certain embodiments, the almond flour is blended with almond protein powder to reduce the oil content of the dough that, with the use of inventive die, further avoids/minimizes oiling out.

### Drying Process

The present invention additionally provides improved methods for drying almond-based and other nut-based pasta products produced using the disclosed nano-refined flour compositions, psyllium husk serum binder systems, and specialized extrusion dies. The drying process is configured to remove moisture efficiently while preserving the structural integrity, dimensional stability, and textural characteristics of the extruded pasta. Due to the unique rheological and lipid properties of nut-based doughs, specialized drying protocols are necessary to prevent cracking, warping, brittleness, or oil migration during dehydration.

The drying process aims to: (a) reduce pasta moisture content to shelf-stable levels; (b) maintain pasta shape and structural integrity; (c) prevent surface defects and internal fracturing; (d) preserve textural attributes for optimal cooking performance; (e) control water migration to avoid oil separation; and (f) Ensure uniform drying across the product.

Initial Surface Drying (Setting Phase): In certain embodiments, drying begins with an initial surface-setting phase, during which the exterior of the pasta is exposed to: moderate temperatures (e.g., 25° C. to 50° C.), and low to moderate humidity levels (e.g., 30% to 60% relative humidity). This phase promotes the formation of a stable outer layer that prevents deformation or collapse of extruded shapes—particularly hollow shapes such as penne or rigatoni. The improved dough formulation containing nano-refined particles and psyllium husk serum facilitates uniform moisture migration, enabling controlled surface setting without excessive cracking.

Primary Drying Phase: Following initial setting, the pasta undergoes the primary drying phase in which: temperatures may range from 35° C. to 70° C.; humidity is gradually reduced; and airflow is regulated to promote consistent drying. In certain embodiments, drying may take place in static drying chambers, conveyor-based drying tunnels, and/or multi-stage humidity-controlled drying systems.

The psyllium husk serum plays a critical role during this phase by distributing moisture more uniformly through the dough matrix, reducing localized stresses that can lead to internal fractures.

Final Conditioning Phase: After primary drying, the pasta may undergo a conditioning or equilibration phase: temperatures may range from 20° C. to 40° C.; humidity may be held at 40% to 60% relative humidity; and duration may be adjusted to ensure uniform moisture distribution. This step prevents brittleness by allowing moisture gradients within the pasta to equalize. Pastas formulated according to this invention exhibit superior tolerance for conditioning due to improved microstructure and reduced internal voids.

In various embodiments, the final dried pasta exhibits a moisture content ranging from 5 percent to 13 percent by weight, depending on regulatory, safety, or textural requirements. Lower moisture targets may be desired for extended shelf stability, while slightly higher moisture levels can provide enhanced flexibility or reduced fragility during packaging.

Traditional gluten-free pastas are prone to brittleness and cracking during drying due to weak structural matrices and inconsistent hydration. The drying methods disclosed herein—combined with the improved dough systems—address these deficiencies through: (a) uniform moisture migration facilitated by micronized flour particles; (b) elastic gel networks formed by the psyllium husk serum; (c) reduced oil separation from the improved die design; and (d) controlled drying temperature and humidity transitions. As a result, the dried pasta exhibits significantly reduced cracking rates and improved durability during handling and packaging.

In certain embodiments, drying conditions are calibrated to prevent oil migration to the pasta surface. Oiling out is minimized due to: reduced shear-induced oil release from the improved extrusion die; nano-refined particle matrices that stabilize natural oils; an structural cohesion provided by the psyllium serum. Drying processes may include airflow and temperature profiles specifically designed to minimize surface oil accumulation.

The disclosed drying process is compatible with industrial static dryers, vertical pasta drying systems, forced-air convection tunnels, multi-stage temperature/humidity controlled rooms, continuous belt dryers, and small-batch or artisanal drying equipment. This compatibility allows for flexible implementation in commercial manufacturing environments.

Pasta dried according to the methods disclosed herein exhibits smooth, uniform exterior surfaces, high structural integrity, reduced brittleness, excellent shape retention, enhanced cooking tolerance and firmness, and minimal surface oil or discoloration. These attributes contribute to superior sensory quality and consumer acceptance.

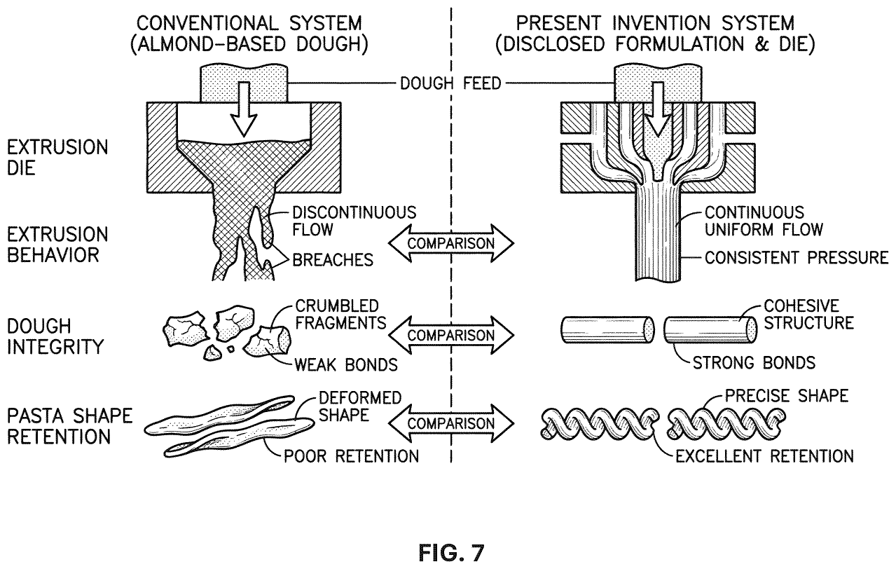

FIG. 7 is a comparative diagram showing differences in extrusion behavior, dough integrity, and pasta shape retention between conventional almond-based dough processed through a traditional die and dough formulated and extruded using the systems disclosed in the present invention.

### Alternative Embodiments

The present invention encompasses numerous alternative embodiments relating to ingredient selection, processing methods, binder systems, extrusion technologies, and final product applications. The variations described herein illustrate the flexibility and adaptability of the disclosed nano-refined flour compositions, psyllium husk serum binder, and extrusion die systems across a broad range of gluten-free and grain-free food products.

Alternative Nut-Based Flours: In addition to almond flour, the particle-size refinement and dough preparation methods disclosed herein may be applied to other nut-based flours having similar lipid and protein characteristics. Suitable alternatives include flours derived from: Hazelnuts; Cashews; Pistachios; Walnuts; Pecans; Macadamia nuts; Pine nuts; Chestnuts; and Brazil nuts. These flours may be used individually or in combination with almond flour. The nano-refinement process enhances hydration, binding, and structural properties regardless of nut type.

In certain embodiments, the flour composition comprises blends of two or more nut-based flours. Such blends may be developed to: (a) balance protein, fat, and fiber content; (b) achieve specific sensory profiles; (c) optimize extrusion or drying performance, or (d) reduce formulation costs. Particle-size refinement may be applied before or after blending to achieve uniformity across the mixture.

Alternative Starch or Carbohydrate Components: While tapioca starch is disclosed in preferred embodiments, the invention contemplates substitution or supplementation with one or more alternative starch sources, including: potato starch; sweet potato starch; arrowroot; corn starch or corn-derived resistant starch; rice starch or rice flour; and modified food starches. Each starch may contribute unique textural, binding, or hydration characteristics suitable for specific product applications.

Although the psyllium husk serum provides significant improvements, additional embodiments of the invention employ additional or alternative binders, including one of more of the following: Xanthan gum; Guar gum; Locust bean gum; Konjac flour; Hydroxypropyl methylcellulose (HPMC); pea protein or other plant-based protein isolates; and/or soluble fibers.

Binders may be used alone, in combination, or in conjunction with the psyllium husk serum to modulate dough elasticity, firmness, or processing behavior.

Serum Variations and Modifications: the psyllium husk serum may be modified through: (a) variation in hydration ratios (e.g., 1:5 to 1:30 psyllium-to-water); (b) use of water at different temperatures; (c) incorporation of acids, bases, or salts; (d) use of ultrasonic, colloid milling, or high-pressure homogenization techniques; and/or € partial or complete dehydration to form rehydratable serum powders. These modifications allow precise control of serum viscosity, gel strength, and functional performance in dough systems.

Alternative Milling and Particle-Refinement Methods: The particle-size refinement processes may include or substitute: Air-classification milling; Cryo-ball milling; Stone milling followed by secondary refinement; Wet milling followed by dehydration; and Multi-pass refinement or staged size-reduction processes. The goal of each method is to achieve fine, uniform particles that improve hydration and binding.

Alternative Extrusion Die Configurations: the improved extrusion die may be configured in: modular components allowing rapid geometry changes; multi-layered assemblies incorporating differing materials (e.g., metal-ceramic composites); perforated or vented structures for pressure modulation; rotational or oscillating die designs for textured or spiral shapes; and/or dual-stream or co-extrusion configurations for filled or layered pasta. These variations maintain the core functional benefits of reduced oiling out and improved flow stability.

Application to Non-Pasta Products: the disclosed flour, serum, and extrusion systems may be applied to additional product categories, including: extruded foods, such as grain-free snacks, crackers or crisps, breakfast cereals, chewy or aerated extruded products; baked goods, such as bread and rolls, muffins and cakes, cookies or biscuits, and pizza crusts; dough-based foods, such as dumplings, gnocchi, tortillas or wraps. plant-based meat analogues. Particle refinement and serum-based binding may provide textural enhancements for plant-based meat formulations.

Functional Modifications for Specific Sensory Attributes: The invention allows tailoring of sensory attributes, such as: firmness or chewiness, surface smoothness, elastic recovery, color or opacity, aroma or flavor absorption. Such variations may be achieved through adjustments in starch type, serum viscosity, particle-size distribution, extrusion conditions, or drying profiles.

Embodiments with Reduced or Modified Oil Content: In certain embodiments, the almond flour may be partially defatted before refinement, oil-binding agents may be added, or additional proteins or fibers may be incorporated to stabilize natural oils. These embodiments further optimize extrusion performance and reduce oiling out.

### ADDITIONAL EXAMPLES

Various examples have already been provided. The following further examples illustrate additional embodiments of the present invention. These and other examples provided herein are not intended to limit the scope of the claims. Variations and modifications apparent to a person of ordinary skill in the art are within the scope of this disclosure.

### Example 1: Production of Nano-Refined Almond Flour

Almond flour (full-fat), almond protein powder, and tapioca starch were individually processed using a cryogenic grinding system. The flour was cooled to approximately −80° C. using liquid nitrogen and then subjected to a precision milling operation. The resulting powders exhibited an average particle size of approximately 5 microns, with a narrow distribution of particle sizes between 2 microns and 8 microns.

The refined almond flour demonstrated: enhanced hydration characteristics, reduced oil separation under shear, and improved integration with psyllium husk serum during dough preparation.

### Example 2: Preparation of Psyllium Husk Serum

Psyllium husk powder (1 part by weight) was combined with water (15 parts by weight) at 50° C. and allowed to hydrate for 10 minutes. The hydrated mixture was then processed using a high-shear rotor-stator mixer for 5 minutes, resulting in a smooth, viscous, serum-like material free of undissolved psyllium particles.

Optional ultrasonic cavitation was applied for 2 minutes to further reduce micro-aggregates. The resulting serum exhibited: uniform gel consistency; particle-size distribution below 50 microns; and viscosity suitable for incorporation into gluten-free dough systems.

### Example 3: Preparation of Dough Using Nano-Refined Flour and Psyllium Serum

A dry blend was prepared comprising: 60% nano-refined almond flour; 20% almond protein powder; 15% tapioca starch; and 5% psyllium husk (optional).

The blended dry ingredients were combined with psyllium husk serum and water (35% hydration basis). The mixture was mechanically kneaded for 10 minutes until a cohesive dough formed.

The resulting dough exhibited high elasticity, no visible oil separation, and excellent cohesiveness suitable for extrusion.

### Example 4: Extrusion of Almond-Based Pasta Using Improved Extrusion Die

The dough prepared in Example 3 above was extruded using a single-screw extruder fitted with the improved extrusion die described herein. The extrusion die included: a 5-degree tapered flow channel; electropolished interior surfaces; and integrated cooling channels maintained at 20° C.

The dough was extruded at a pressure of 650 psi, forming smooth, dimensionally stable fusilli pasta shapes. Extrusion performance included: no clogging or fouling within the die; no oiling out at the die exit; and uniform geometry across all strands.

### Example 5: Drying of Almond-Based Pasta

The extruded pasta from Example 4 was dried in a humidity-controlled drying chamber. Drying parameters included: initial setting phase at 35° C. and 50% humidity for 20 minutes; primary drying at 55° C. and 30% humidity for 3 hours; final conditioning at 25° C. and 55% humidity for 1 hour. The final moisture content was 10% by weight.

The dried pasta exhibited smooth surface texture, no cracking or brittleness, strong shape retention during cooking.

### Example 6: Comparison With Conventional Almond-Based Dough

A control dough was prepared using conventional almond flour (non-refined), powdered psyllium husk, tapioca starch, and water. The control dough: exhibited significant brittleness during mixing; released oil during extrusion; produced pasta strands with rough surfaces and irregular geometry; demonstrated higher breakage during drying.

In contrast, dough prepared according to the present invention showed superior cohesion, extrusion stability, and finished product quality.

### Example 7: Application to Non-Almond Nut Flours

Walnut flour and hazelnut flour were refined using jet milling to a particle size of approximately 3 microns. A dough composed of: 50% refined walnut flour; 25% refined hazelnut flour; 15% tapioca starch; 10% psyllium husk serum (hydrated at 1:12 ratio), was prepared and extruded using the improved extrusion die.

The resulting pasta products: exhibited smooth surfaces and uniform density, maintained structural integrity during cooking, and demonstrated reduced oiling out despite high lipid content of walnut flour.

### Example 8: Serum-Only Binder System

A formulation was created omitting powdered psyllium entirely. Nano-refined almond flour and almond protein powder were hydrated using psyllium husk serum as the sole binder. The dough demonstrated high cohesion and elasticity, smooth extrusion behavior, and cooking performance comparable to wheat-based pasta. This example illustrates that the psyllium serum alone is sufficient to provide structural support in certain embodiments

### Example 9: Multi-Stage Refinement Process

A blend of almond flour and tapioca starch was subjected to: (1) cryogenic grinding to reduce particles to approximately 10 microns; (2) jet milling to further reduce particles to 2 microns; and (3) sieving to remove oversize particles. This multi-stage refinement produced flour with exceptional hydration uniformity, resulting in doughs with improved smoothness and reduced variability in extrusion performance.

Having described the present invention and its features and benefits, it should be appreciated that the present invention includes any and all possible combinations of the disclosed subject matter. Thus, even if a particular embodiment is not discussed as including a feature in a different embodiment, the present invention embodies such feature in any suitable embodiment, and accordingly such particular embodiment optionally includes said particular features of said different embodiment.

Unless otherwise stated, the singular includes the plural in further variations and the plural includes the singular in other further variations of any particular described embodiment, feature, element, step or other thing mentioned herein.

Having described the present invention including various features and variations thereof, it is intended that the appended claims be interpreted as including the embodiments described herein, the alternatives mentioned above, and all equivalents thereto.

The foregoing description illustrates various embodiments of the invention and is not intended to be exhaustive or to limit the invention to the precise forms disclosed. Numerous modifications, variations, substitutions, and additions will be apparent to a person of ordinary skill in the art in view of the teachings herein. The specific embodiments described herein are presented for purposes of illustration, and should not be construed as limiting the scope of the invention as defined by the appended claims.

Unless otherwise indicated, all numerical values, ranges, and ratios disclosed herein are intended to be approximate and may vary depending on processing conditions, ingredient sources, or manufacturing tolerances. Numerical ranges disclosed herein are intended to include all sub-ranges and individual values within the stated range. Where the terms “about,” “approximately,” or similar language is used in connection with a numerical value or range, such modifiers are intended to account for variations in measurement, processing, and material performance consistent with normal engineering and scientific practice.

Reference to singular elements shall be understood to include plural forms unless expressly stated otherwise, and reference to plural elements shall be understood to include singular forms where applicable. The conjunction “or” is intended to mean “and/or” unless expressly indicated otherwise.

Any feature, element, step, characteristic, or component described in connection with any embodiment may be used alone or in combination with other features, elements, steps, characteristics, or components described herein unless expressly stated otherwise. The invention encompasses all combinations and sub-combinations of the features and elements disclosed herein.

It is intended that the appended claims cover all modifications and variations that fall within the true scope and spirit of the invention. The scope of the invention is defined solely by the claims, and nothing in the specification should be interpreted as limiting the claims beyond their express recitations.

What is claimed is:

1. A flour composition, comprising:
almond flour refined to an average particle size of between 0.1 microns and 10 microns;
almond protein powder refined to an average particle size of between 0.1 microns to 10 microns; and
tapioca starch refined to an average particle size of between 0.1 microns and 10 microns;
the flour composition exhibiting a substantially uniform particle-size distribution and is configured to form a cohesive, gluten-free dough suitable for extrusion into pasta.

2. The flour composition of claim 1, wherein the almond flour comprises 30 percent to 80 percent by weight of the flour composition.

3. The flour composition of claim 1, wherein the almond protein powder comprises 5 percent to 40 percent by weight of the flour composition.

4. The flour composition of claim 1, wherein the tapioca starch comprises 5 percent to 25 percent by weight of the flour composition.

5. The flour composition of claim 1, further comprising psyllium husk powder refined to an average particle size of between 0.1 microns and 10 microns.

6. The flour composition of claim 1, wherein at least 80 percent of all particles fall within ±20 percent of the mean particle size.

7. The flour composition of claim 1, wherein one or more of the almond flour, the almond protein powder, and the tapioca starch is refined to an average particle size below 1 micron.

8. A dough composition, comprising:
a flour composition comprising almond flour, almond protein powder, and tapioca starch, each refined to an average particle size of between 0.1 microns and 10 microns;
a psyllium husk serum including hydrated psyllium husk subjected to mechanical refinement to form a smooth, gel-like medium; and
water;
the dough composition exhibiting improved elasticity, cohesiveness, and reduced oil separation relative to dough compositions comprising unrefined almond flour.

9. The dough composition of claim 8, wherein the psyllium husk serum comprises 1 part psyllium husk to 10 to 25 parts water by weight.

10. The dough composition of claim 8, wherein the psyllium husk serum has been processed via one or more of high-shear mixing, homogenization, and ultrasonic cavitation.

11. The dough composition of claim 8, wherein the dough composition exhibits reduced brittleness after drying compared with dough comprising unrefined almond flour.

12. The dough composition of claim 8, wherein the almond flour is partially defatted prior to refinement.

13. The dough composition of claim 8, further comprising flour derived from one or more of hazelnut, cashew, pistachio, walnut, macadamia, and pecan.

14. A method of producing a dough suitable for gluten-free pasta, comprising:
refining each of almond flour, almond protein powder, and tapioca starch to an average particle size of between 0.1 microns and 10 microns;
preparing a psyllium husk serum by hydrating psyllium husk in water and mechanically processing the hydrated psyllium to form a uniform, serum-like material;
mixing the refined almond flour, refined almond protein powder, and refined tapioca starch to form a dry mixture;
adding the psyllium husk serum to the dry mixture to produce a combined mixture; and
hydrating and mixing the combined mixture to form a cohesive dough, the formed cohesive dough having structural integrity if extruded.

15. The method of claim 14, wherein refining the almond flour is carried out by one or more of cryogenic grinding, jet milling, ball milling, and ultrasonic milling.

16. The method of claim 14, wherein the psyllium husk serum is further processed by ultrasonic cavitation to reduce gel microstructures.

17. The method of claim 14, further comprising allowing the formed cohesive dough to rest for 5 to 20 minutes; and extruding the rested formed cohesive dough.

18. A method of manufacturing gluten-free pasta, comprising:
producing a dough according to claim 14;
extruding the dough through an extrusion die configured for high-oil doughs; and
drying the extruded dough to form a shelf-stable pasta product;
wherein extrusion of the dough results in reduced oil separation relative to extrusion of doughs comprising unrefined almond flour.

19. The method of claim 18, wherein drying comprises a surface-setting phase, a primary drying phase, and a final conditioning phase.

20. The method of claim 18, wherein extrusion is performed using a cold-extrusion pasta press.

21. An extrusion die for processing high-oil gluten-free doughs, comprising:
a die body;
the die body having one or more flow channels, each of the flow channels having a tapered geometry configured to reduce shear stress and minimize oil separation during extrusion;
the flow channels having a surface finish comprising an electropolished or non-stick coating configured to reduce dough adhesion; and
one or more shaping orifices configured to form an extruded pasta product;
wherein the extrusion die is configured to produce dimensionally stable pasta shapes from almond-based doughs.

22. The extrusion die of claim 21, comprising integrated cooling channels configured to dissipate heat generated during extrusion.

23. The extrusion die of claim 21, wherein the shaping orifices are configured to form hollow pasta shapes including penne, rigatoni, or bucatini.

24. The extrusion die of claim 21, wherein the tapered flow channel has a taper angle of between 3 degrees to 10 degrees.

25. The extrusion die of claim 21, further comprising a modular insert configured to allow rapid modification of pasta shapes.

26. A system for producing gluten-free pasta, comprising:
a particle-refinement apparatus configured to refine almond flour, almond protein powder, and tapioca starch to particle sizes of between 0.1 microns and 10 microns;
a psyllium serum preparation apparatus configured to hydrate and mechanically refine psyllium husk;
a dough mixer configured to combine refined flour particles, psyllium serum, and water; and
the extrusion die of claim 21;
wherein the system is configured to produce extruded nut-based pasta with reduced oil separation and improved structural integrity.

27. The system of claim 26, configured to dry pasta at controlled temperatures and humidity levels.

28. The system of claim 26, wherein the particle-refinement apparatus comprises a multi-stage refinement sequence including cryogenic grinding and jet milling.

29. The system of claim 26, wherein the psyllium serum preparation apparatus comprises a high-shear mixer and an ultrasonic processor.

30. The system of claim 26, wherein the system is configured to produce non-pasta extruded food products selected from the group consisting of crackers, snacks, cereals, and dough-based foods.
